(19) United States
(12) Patent Application Publication
(10) Pub. No.: US 2026/0166437 A1
(43) Pub. Date: Jun. 18, 2026

(54) USER GENERATED CONTENT GENERATION WITH MOTION POINT CONTROL IN GAME PROGRAM

(71) Applicant: Tencent Technology (Shenzhen) Company Limited, Shenzhen (CN)

(72) Inventors: Jiahui LI, Shenzhen (CN); Zhiyang FU, Shenzhen (CN); Gongxian CAI, Shenzhen (CN)

(73) Assignee: Tencent Technology (Shenzhen) Company Limited, Shenzhen (CN)

(21) Appl. No.: 19/440,572

(22) Filed: Jan. 5, 2026

Related U.S. Application Data
(63) Continuation of application No. PCT/CN2024/104461, filed on Jul. 9, 2024.

(30) Foreign Application Priority Data
Sep. 12, 2023 (CN) 202311183367.7

(51) Int. Cl. A63F 13/63

(52) U.S. Cl. CPC A63F 13/63

(57) ABSTRACT

In a method for generating user generated content (UGC) in a game program, a virtual object located in a virtual environment is output for display in an editor interface of a UGC editor. Based on a motion point editing operation performed on a motion path of the virtual object, at least one motion point for the virtual object in the virtual environment is set. The at least one motion point indicates a motion parameter of the virtual object on the motion path of the virtual environment. A motion of the virtual object in the virtual environment is controlled based on the at least one motion point.

### RELATED APPLICATIONS

The present application is a continuation of International Application No. PCT/CN 2024/104461, filed on Jul. 9, 2024, which claims priority to Chinese Patent Application No. 202311183367.7, filed on Sep. 12, 2023. The entire disclosures of the prior applications are hereby incorporated by reference.

### FIELD OF THE TECHNOLOGY

This application relates to the field of games, including a method for generating UGC in a game program.

### BACKGROUND OF THE DISCLOSURE

User generated content (UGC) refers to self-created content shared by a user on the Internet. In the field of games, a designer encourages a user to participate in the design of game content such as a level map, a gameplay, and an ecosystem by providing a corresponding UGC editing capability in a game. When the user designs the level map, objects are usually moved, to increase difficulty and interest of a level.

### SUMMARY

Aspects of this disclosure provide a method for generating UGC in a game program, an information processing apparatus, and a non-transitory computer-readable storage medium. Examples of technical solutions of this disclosure may be implemented as follows:

An aspect of this disclosure provides a method for generating user generated content (UGC) in a game program. In the method, a virtual object located in a virtual environment is output for display in an editor interface of a UGC editor. Based on a motion point editing operation performed on a motion path of the virtual object, at least one motion point for the virtual object in the virtual environment is set. The at least one motion point indicates a motion parameter of the virtual object on the motion path of the virtual environment. A motion of the virtual object in the virtual environment is controlled based on the at least one motion point.

An aspect of this disclosure provides an information processing apparatus. The apparatus includes processing circuitry configured to output for display, in an editor interface of a UGC editor, a virtual object located in a virtual environment. The processing circuitry is configured to set, based on a motion point editing operation performed on a motion path of the virtual object, at least one motion point for the virtual object in the virtual environment. The at least one motion point indicates a motion parameter of the virtual object on the motion path of the virtual environment. The processing circuitry is configured to control a motion of the virtual object in the virtual environment based on the at least one motion point.

An aspect of this disclosure provides a method for generating UGC in a game program. The method is performed by a computer device. The computer device runs the game program. The game program has a UGC editor. The UGC editor is configured to enable user-defined creation of a motion object in a virtual environment. The method includes: displaying a virtual object located in a virtual environment in an editor interface of the UGC editor; setting a motion point for the virtual object in the virtual environment in response to a motion point editing operation for the virtual object, the motion point indicating a motion parameter of the virtual object on a motion path of the virtual environment; and controlling a motion of the virtual object in the virtual environment based on the motion point.

An aspect of this disclosure provides an apparatus for generating UGC in a game program. The apparatus is configured in a computer device. The computer device runs the game program. The game program has a UGC editor. The UGC editor is configured to enable user-defined creation of a motion object in a virtual environment. The apparatus includes: a first display module, configured to display a virtual object located in a virtual environment in an editor interface of the UGC editor; a setting module, configured to set a motion point for the virtual object in the virtual environment in response to a motion point editing operation for the virtual object, the motion point indicating a motion parameter of the virtual object on a motion path of the virtual environment; and a control module, configured to control a motion of the virtual object in the virtual environment based on the motion point.

An aspect of this disclosure provides a computer device. The computer device includes a processor and a memory. The memory has a computer program stored therein. The computer program is loaded and executed by the processor to implement the foregoing methods for generating UGC in a game program.

An aspect of this disclosure provides a non-transitory computer-readable storage medium storing instructions which, when executed by a processor, cause the processor to implement the foregoing methods for generating UGC in a game program.

An aspect of this disclosure provides a computer program product. The computer program product includes a computer program. The computer program is stored in a computer-readable storage medium. The computer program is read and executed from the computer-readable storage medium by a processor of a computer device, to enable the computer device to perform the foregoing methods for generating UGC in a game program.

The foregoing technical solutions support a user to set a motion status of a virtual object in a virtual environment by setting motion points in the virtual environment. The user only needs to set motion parameters of the motion points, so that the computer device generates a motion process in which the virtual object moves from a first motion point to a last motion point. For example, the user may intuitively set and edit the motion points of the virtual object in the virtual environment, and the user can design a complex motion of the virtual object in the virtual environment only by focusing on the design of the motion points, so that the motion process of the virtual object is more likely to be customized and adjusted, thereby simplifying a user-defined creation process, reducing difficulty of the user in designing a motion of the virtual object in the virtual environment, and improving operation efficiency.

### BRIEF DESCRIPTION OF THE DRAWINGS

FIG. 1 shows a schematic diagram of a computer system according to an aspect of this disclosure.

FIG. 2 shows a schematic diagram of a computer system according to an aspect of this disclosure.

FIG. 3 shows a flowchart of a method for generating UGC in a game program according to an aspect of this disclosure.

FIG. 4 shows a flowchart of a method for generating UGC in a game program according to an aspect of this disclosure.

FIG. 5 shows a flowchart of a method for generating UGC in a game program according to an aspect of this disclosure.

FIG. 6 shows a flowchart of a method for generating UGC in a game program according to an aspect of this disclosure.

FIG. 7 shows a schematic diagram of a method for generating UGC in a game program according to an aspect of this disclosure.

FIG. 8 shows a flowchart of a method for generating UGC in a game program according to an aspect of this disclosure.

FIG. 9 shows a schematic diagram of a method for generating UGC in a game program according to an aspect of this disclosure.

FIG. 10 shows a schematic diagram of a method for generating UGC in a game program according to an aspect of this disclosure.

FIG. 11 shows a schematic diagram of a method for generating UGC in a game program according to an aspect of this disclosure.

FIG. 12 shows a flowchart of a method for generating UGC in a game program according to an aspect of this disclosure.

FIG. 13 shows a flowchart of a method for generating UGC in a game program according to an aspect of this disclosure.

FIG. 14 shows a schematic diagram before and after a path smoothing operation according to an aspect of this disclosure.

FIG. 15 shows a flowchart of a method for generating UGC in a game program according to an aspect of this disclosure.

FIG. 16 shows a schematic diagram of a method for generating UGC in a game program according to an aspect of this disclosure.

FIG. 17 shows a schematic diagram of a method for generating UGC in a game program according to an aspect of this disclosure.

FIG. 18 shows a schematic diagram of a method for generating UGC in a game program according to an aspect of this disclosure.

FIG. 19 shows a schematic diagram of a method for generating UGC in a game program according to an aspect of this disclosure.

FIG. 20 shows a schematic diagram of a method for generating UGC in a game program according to an aspect of this disclosure.

FIG. 21 shows a schematic diagram of a method for generating UGC in a game program according to an aspect of this disclosure.

FIG. 22 shows a flowchart of a method for generating UGC in a game program according to an aspect of this disclosure.

FIG. 23 shows a flowchart of a method for generating UGC in a game program according to an aspect of this disclosure.

FIG. 24 shows a structural block diagram of an apparatus for generating UGC in a game program according to an aspect of this disclosure.

FIG. 25 shows a structural block diagram of a computer device according to an aspect of this disclosure.

### DETAILED DESCRIPTION

To make the objects, technical solutions, and advantages of this disclosure clearer, the following describes implementations of this disclosure in further detail with reference to the accompanying drawings. Further, the descriptions of the terms are provided as examples and are not intended to limit the scope of the disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

First, examples of related terms involved in this disclosure will be introduced below.

UGC: self-created content shared by a user on the Internet. In the field of games, a designer encourages a user to participate in the design of game content such as a level map, a gameplay, and an ecosystem by providing a corresponding UGC editing capability in a game. By designing the game content by the user, a feeling of membership of the user and richness of the game content are improved, thereby further satisfying a personalized requirement.

Virtual Environment: a virtual environment displayed (or provided) when a client is run on a terminal. The virtual environment may be a simulated environment of a real world, or may be a semi-simulated and semi-fictional environment, or may be an entirely fictional environment. The virtual environment may be any one of a two-dimensional virtual environment, a 2.5-dimensional virtual environment, and a three-dimensional virtual environment. This is not limited in this disclosure. The following aspects are described by using an example in which the virtual environment is a three-dimensional virtual environment.

In related art, a motion of a single object is designed in a manner of superimposing motions on the object. When the user wants to control an object to complete a multi-segment or multi-dimensional complex motion, the user needs to disassemble the complex motion into a plurality of different simple motions. For example, to implement a low-to-high helically curved motion of the object, the motion needs to be disassembled into a circular motion and a low-to-high rectilinear motion, and a motion speed and a motion time further need to be constantly adjusted to achieve a target effect.

The foregoing solution is difficult for a common user, and does not help the user to further participate in design of game content. How to design an object motion design method that is easily operated by the user is a problem to be urgently resolved currently. Based on this, this disclosure provides a method for generating UGC in a game program. For a detailed process, reference can be made to the following aspects.

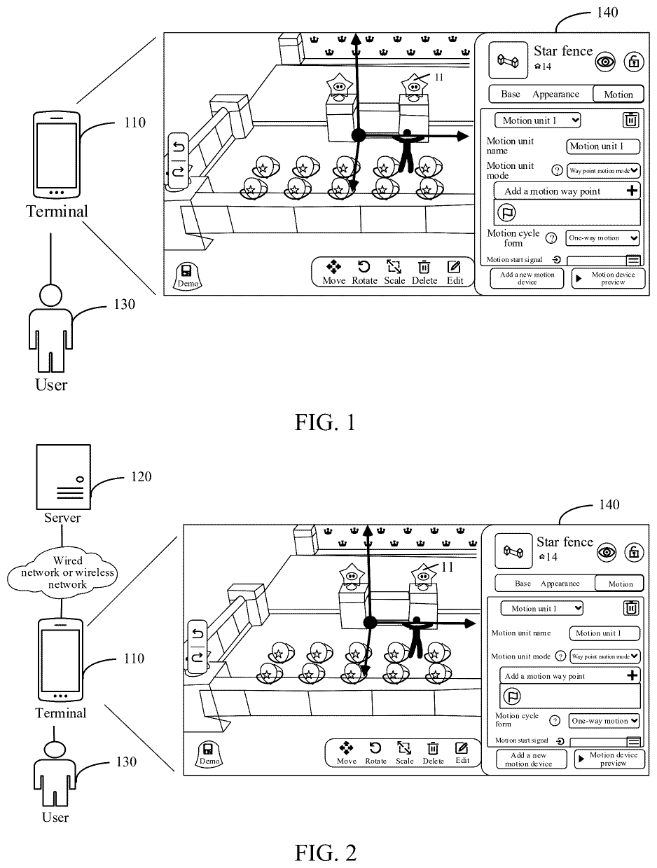

FIG. 1 and FIG. 2 show a schematic diagram of a computer system according to an aspect of this disclosure. The computer system may include a terminal 110 and a server 120. The terminal 110 may be a laptop portable computer, a desktop computer, a mobile phone, a tablet computer, an e-book reader, an electronic game console, or the like.

The terminal 110 includes a memory and a processor. The memory may include one or more computer-readable storage media. The computer-readable storage medium includes at least one of a random access memory (RAM), a read only memory (ROM), and a flash. An operating system and a game program are installed in the memory. The game program is designed with an editor interface 140.

The game program may be any one of a level-based game, a casual competitive game, a massive multiplayer online game (MMOG), a chess and card game, a multiplayer online battle arena (MOBA) game, a simulation game (SLG), a virtual reality application, a three-dimensional map program, a first-person shooting (FPS) game, a multiplayer survival shooter game, a casual game, a party game, or a sandbox game.

The operating system is basic software provided for the game program to perform secure access to computer hardware. The operating system may be Android or IOS. The operating system supports downloading, installation, and running of the game program.

In some aspects, the terminal 110 further includes a touchscreen. The touchscreen may be a capacitive screen or a resistive screen. The touchscreen is configured to implement interaction between the terminal and a user 130. In this aspect of this disclosure, the terminal obtains, by using the touchscreen, an interaction operation triggered by the user 130 on the editor interface 140 of a UGC editor in the game program.

The editor interface 140 supports the user 130 to perform an operation such as editing, saving, or publishing on a virtual environment. When editing the virtual environment, the user 130 may set up different virtual environments by using a virtual object. The UGC editor supports the user 130 to create a motion object to enrich the virtual environment, thereby improving operability and interest of the user.

The terminal 110 is a terminal used by the user 130. The user 130 uses the terminal 110 to operate the editor interface 140, and the user 130 may save a virtual environment that is being edited or is edited into the terminal 110. In some aspects, the terminal 110 is configured to upload virtual environment information saved by the user 130 to the server 120. Alternatively, the terminal 110 is configured to provide data information of the virtual environment and the virtual object to the game program. Alternatively, the terminal 110 is configured to save motion point information.

In some aspects, the computer system further includes a server 120, as shown in FIG. 2. The server 120 may be any one of a plurality of servers, virtual cloud storage, or a cloud computing center. In some aspects, the server 120 is configured to save virtual environment information uploaded by the terminal 110. Alternatively, the server 120 is configured to save motion point information uploaded by the terminal 110. Alternatively, the server 120 is configured to provide data information of the virtual environment and the virtual object to the game program.

In some aspects, the terminal 110 and the server 120 are connected to each other by a wired or wireless network.

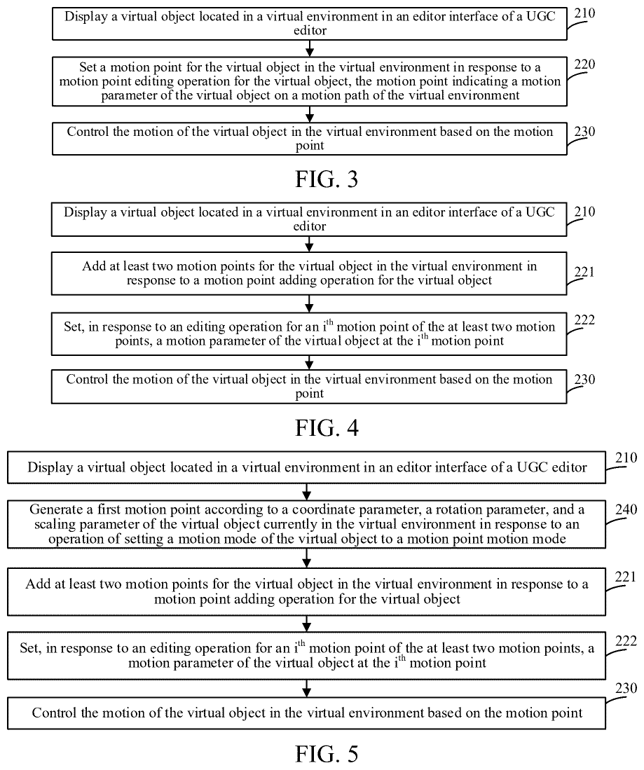

FIG. 3 shows a schematic diagram of a method for generating UGC in a game program according to an aspect of this disclosure. The method is performed by a terminal. The terminal may be the terminal shown in FIG. 1 and FIG. 2. The method includes the following operations.

Operation 210: Display a virtual object located in a virtual environment in an editor interface of a UGC editor. For example, a virtual object located in a virtual environment is output for display in an editor interface of a UGC editor.

The terminal runs a game program. The game program has a UGC editor. The UGC editor is configured to enable user-defined creation of a motion object in a virtual environment. A user may create, edit, and customize content in the game program by using the UGC editor.

The UGC editor is provided with an editor interface. The game program is provided with a virtual environment. The virtual environment includes a virtual object. The editor interface may display the virtual environment and the virtual object located in the virtual environment.

In some aspects, a virtual environment picture is displayed in the editor interface of the UGC editor. The virtual environment picture is a picture obtained by shooting the virtual environment using a camera model. The user may control the camera model by interactive operation for a touchscreen, thereby changing a display effect of the virtual environment picture, for example, changing a display angle of the virtual environment picture by adjusting a shooting angle of the camera model.

In some aspects, the virtual object is a virtual object that supports a motion.

In some aspects, the virtual object is provided by the UGC editor. Alternatively, the virtual object is obtained by combining virtual objects provided by the UGC editor by the user. Alternatively, the virtual object is generated by the UGC editor after the user imports a picture into the UGC editor. Alternatively, the virtual object is a virtual object created by the user of the UGC editor and saved in a common library.

Operation 220: Set a motion point for the virtual object in the virtual environment in response to a motion point editing operation for the virtual object, the motion point indicating a motion parameter of the virtual object on a motion path of the virtual environment. For example, based on a motion point editing operation performed on a motion path of the virtual object, at least one motion point for the virtual object in the virtual environment is set. The at least one motion point indicates a motion parameter of the virtual object on the motion path of the virtual environment.

The motion point editing operation is an operation of requesting to edit a motion point. For example, if a motion point editing control is displayed on the editor interface, the motion point editing operation is a trigger operation for the motion point editing control.

The motion point may refer to a space point on the motion path in the virtual environment, namely a position on the motion path. The virtual object may move along the motion path formed by the plurality of motion points. However, in this aspect of this disclosure, the motion point not only indicates a space point, but also indicates a motion parameter at the space point. For example, the motion point not only indicates a position, but also indicates a motion parameter at the position. The motion point carries a motion parameter. The motion parameter indicates a motion manner such as a moving direction, a moving speed, a rotation angle, or a scaling ratio.

In this aspect of this disclosure, one or more motion points may be set. For example, at least two motion points are set.

In some aspects, the motion point is referred to as a way point for short, but is different from a conventional way point which only represents one coordinate. The motion point is configured for indicating the motion parameter of the space point of the virtual object on the motion path of the virtual environment.

In some aspects, the motion point in the virtual environment is displayed as a simple graph. Alternatively, the motion point in the virtual environment is displayed as a virtual object copy. Alternatively, the motion point in the virtual environment is displayed as a virtual object copy reduced to a first threshold. Alternatively, the motion point in the virtual environment is displayed as a combined graph of the simple graph and the virtual object copy reduced to the first threshold. The first threshold is a positive number less than 1.

Schematically, the motion point in the virtual environment is displayed as a black ball. Alternatively, the motion point in the virtual environment is displayed as a virtual object copy, and the virtual object copy is obtained by copying the virtual object in proportion. Alternatively, the motion point in the virtual environment is displayed as a virtual object copy reduced by 0.5 times. Alternatively, the motion point in the virtual environment is displayed as a virtual object copy wrapped by a black hollow sphere and reduced by 0.5 times.

In some aspects, auxiliary information is displayed in the editor interface of the UGC editor in response to a motion point editing operation for the virtual object.

The auxiliary information includes at least one of a starting point identifier, a motion connection line, a selected motion point, or an unselected motion point. The starting point identifier is an identifier of a first motion point. The motion connection line is a connection line connected between adjacent motion points in dashed lines. The selected motion point is a motion point in a selected state. The unselected motion point is a motion point that is not in a selected state. The selected motion point is highlighted relative to the unselected motion point. For example, the selected motion point has a highlighted frame, and the unselected motion point is displayed in a translucent form.

In some aspects, the motion point is a position point of the virtual object on the motion path of the virtual environment. The motion point indicates a motion parameter of the virtual object when moving to the position point. The motion parameter includes at least one of a coordinate parameter, a rotation parameter, or a scaling parameter.

Operation 230: Control a motion of the virtual object in the virtual environment based on the motion point. For example, a motion of the virtual object in the virtual environment is controlled based on the at least one motion point.

The motion of the virtual object in the virtual environment is controlled, so that the virtual object passes through the motion point during the motion. For example, in the presence of a plurality of motion points, a motion path formed by sequentially connecting the plurality of motion points is determined, and the virtual object is controlled to move along the motion path in the virtual environment.

In some aspects, the motion of the virtual object in the virtual environment is controlled based on motion parameters of at least two motion points.

In some aspects, the motion parameter includes a coordinate parameter. The coordinate parameter is configured for describing a position of the virtual object in the virtual environment. For example, the coordinate parameter may be three-dimensional coordinates or two-dimensional coordinates. The virtual object is controlled to move along a shortest path between adjacent motion points based on the coordinate parameters of the at least two motion points. Alternatively, the virtual object is controlled to move along a smooth curve between adjacent motion points in response to a path smoothing operation based on the coordinate parameters of the at least two motion points. Alternatively, the virtual object is controlled to move along a motion path in response to a setting operation for the motion path based on the coordinate parameters of the at least two motion points. The motion path includes the at least two motion points. The motion path is a motion path provided by the UGC editor. Alternatively, the motion path is a motion path obtained after the user adjusts the motion path provided by the UGC editor.

In some aspects, the motion parameter includes a rotation parameter. The rotation parameter is configured for describing a rotation attitude of the virtual object in the virtual environment. For example, the rotation parameter includes an angle, a direction, and the like. The rotation parameter of the virtual object is controlled to gradually change from a rotation parameter of an i^{th} motion point to a rotation parameter of an (i+1)^{th} motion point based on rotation parameters of at least two motion points when moving between adjacent motion points. Alternatively, the rotation parameter of the virtual object at the i^{th} motion point is controlled to change to the rotation parameter toward the (i+1)^{th} motion point in response to an automatic rotation operation for the i^{th} motion point based on the rotation parameters of the at least two motion points. Alternatively, the rotation parameter of the virtual object at the i^{th} motion point is controlled to change to the rotation parameter of the (i+1)^{th} motion point based on the rotation parameters of the at least two motion points. Alternatively, the virtual object is controlled to rotate according to a rotation curve in response to a setting operation for the rotation curve based on the rotation parameters of the at least two motion points. The rotation curve is a rotation curve provided by the UGC editor. Alternatively, the rotation curve is a rotation curve obtained after the user adjusts the rotation curve provided by the UGC editor, where i is a positive integer.

In some aspects, the motion parameter includes a scaling parameter. The scaling parameter is configured for describing a size change of the virtual object in the virtual environment, and reflecting a scaling-in or scaling-out effect of the virtual object in various directions. For example, the scaling parameter includes a scaling ratio and the like. The scaling parameter of the virtual object is controlled to gradually change from a scaling parameter of an i^{th} motion point to a scaling parameter of an (i+1)^{th} motion point based on scaling parameters of at least two motion points when moving between adjacent motion points. Alternatively, the scaling parameter of the virtual object is controlled, based on the scaling parameters of the at least two motion points, to change to the scaling parameter of the i^{th} motion point when the virtual object moves to the i^{th} motion point. Alternatively, the virtual object is controlled to scale according to a scaling curve in response to a setting operation for the scaling curve based on the scaling parameters of the at least two motion points. The scaling curve is a scaling curve provided by the UGC editor. Alternatively, the scaling curve is a scaling curve obtained after the user adjusts the scaling curve provided by the UGC editor.

In conclusion, according to the method provided in this aspect of this disclosure, a user controls, through an editing operation for motion points, a virtual object to move in a virtual environment according to the motion points. The motion points are edited to split a complex motion of the virtual object in the virtual environment into simple motions between the plurality of motion points, so that the user can quickly control the motion of the virtual object in the virtual environment without related experience.

The editing operation for the motion points includes at least one of an addition operation or an editing operation. In an aspect based on FIG. 3, as shown in FIG. 4, operation 220 may be alternatively implemented as operation 221 and operation 222.

Operation 221: Add at least two motion points for the virtual object in the virtual environment in response to a motion point adding operation for the virtual object. For example, at least two motion points for the virtual object in the virtual environment are added based on a motion point adding operation performed on the motion path of the virtual object.

In some aspects, the motion point adding operation includes at least two of a new motion point adding operation and a motion point copy operation.

In some aspects, one virtual object may have n motion points, where n is a positive integer.

Operation 222: Set, in response to an editing operation for an i^{th} motion point of the at least two motion points, a motion parameter of the virtual object at the i^{th} motion point. For example, based on an editing operation performed on an i^{th} motion point of the at least two motion points, a motion parameter of the virtual object at the i^{th} motion point is set. The motion parameter includes at least one of a coordinate parameter, a rotation parameter, or a scaling parameter of the virtual object at the i^{th} motion point, i being a positive integer.

The motion parameter includes at least one of a coordinate parameter, a rotation parameter, or a scaling parameter of the virtual object at the i^{th} motion point, where i is a positive integer.

In some aspects, the editing operation for the motion point includes at least one of a moving operation, a rotation operation, or a scaling operation.

In some aspects, the editing operation for the motion point may change the motion parameter of the motion point. For example, the editing operation for the motion point is an editing operation for the motion parameter of the motion point.

For example, the moving operation for the motion point is configured for setting the coordinate parameter of the motion point. Alternatively, the rotation operation for the motion point is configured for setting the rotation parameter of the motion point. Alternatively, the scaling operation for the motion point is configured for setting the scaling parameter of the motion point.

In some aspects, the motion parameter of a motion point indicates a motion state of the virtual object when moving to the motion point. The motion state includes at least one of three-dimensional coordinates, a rotation posture, or a scaling ratio. The motion parameter indicates three-dimensional coordinates of the virtual object. The rotation parameter indicates the rotation posture of the virtual object. The scaling parameter indicates the scaling ratio of the virtual object.

In some aspects, the motion parameter is presented in at least one of a coordinate form, a numerical form, a character string form, and a set form. For ease of representation, in this aspect of this disclosure, the expression form of the motion parameter is abstracted into the coordinate form. For example, the coordinate parameter is (14, 8, 54), the rotation parameter is (0, 25, 81), and the scaling parameter is (1, 5, 0.5). Coordinate origins of the virtual object are all (0, 0, 0). The coordinate parameter (14, 8, 54) of the motion point indicates that the virtual object moves, at the motion point, by 14 units relative to the coordinate origin in a positive semi-axis direction of an x-axis, moves by eight units relative to the coordinate origin in a positive semi-axis direction of a y-axis, and moves by 54 units relative to the coordinate origin in a positive semi-axis direction of a z-axis. The rotation parameter (0, 25, −81) of the motion point indicates that the virtual object deflects, at the motion point, by 25 degrees relative to the coordinate origin in the positive semi-axis direction of the y-axis, and deflects by 81 degrees relative to the coordinate origin in a negative semi-axis direction of the z-axis. The scaling parameter (1, −5, 0.5) of the motion point indicates that the size of the virtual object, at the motion point, in the positive semi-axis direction of the x-axis relative to the coordinate origin is 1 time. For example, a preset value is multiplied by 1. The size in a negative semi-axis direction of the y-axis relative to the coordinate origin is 5 times of the preset value. The size in the positive semi-axis direction of the z-axis relative to the coordinate origin is 0.5 times of the preset value. The preset value of the scaling parameter in the x-axis is a length of the virtual object, the preset value in the y-axis is a width of the virtual object, and the preset value in the z-axis is a height of the virtual object.

In some aspects, operation 221 may be implemented as an independent aspect, and operation 222 may be implemented as an independent aspect. Operation 221 and operation 222 may be performed in an alternate order or simultaneously.

In conclusion, according to the method provided in this aspect of this disclosure, an editing operation for a motion point is split into motion point adding and motion point editing. A motion of a virtual object in a virtual environment is split into motions at a plurality of motion points by means of the motion point adding, and further, motion parameters of the motion points are edited, to indicate how the virtual object moves at the motion points, so that a complex motion is formed by combining the motions between the plurality of motion points.

In an aspect based on FIG. 4, as shown in FIG. 5, the method further includes operation 240.

Operation 240: Generate a first motion point according to a coordinate parameter, a rotation parameter, and a scaling parameter of the virtual object currently in the virtual environment in response to an operation of setting a motion mode of the virtual object to a motion point motion mode. For example, a first motion point is generated based on a coordinate parameter, a rotation parameter, and a scaling parameter of the virtual object currently in the virtual environment based on a motion mode of the virtual object.

The coordinate parameter represents three-dimensional coordinates of the virtual object in the virtual environment. The rotation parameter represents a rotation posture of the virtual object in the virtual environment. The scaling parameter represents a scaling ratio of the virtual object in the virtual environment.

In some aspects, the coordinate parameter, the rotation parameter, and the scaling parameter of the virtual object in the virtual environment are preset by the UGC editor. Alternatively, the coordinate parameter, the rotation parameter, and the scaling parameter of the virtual object in the virtual environment are obtained after adjustment by a user.

In some aspects, a first motion point has a starting point identifier. For example, the starting point identifier is a flag. Alternatively, the starting point identifier is a highlighted simple shape. Alternatively, the starting point identifier is an icon.

In conclusion, according to the method provided in this aspect of this disclosure, when a user sets a motion mode of a virtual object to a motion point motion mode, a first motion point, namely a starting point, is automatically generated according to a current state of the virtual object without the need of the user to search for a control to create, thereby improving editing efficiency of the user and friendliness of a game program.

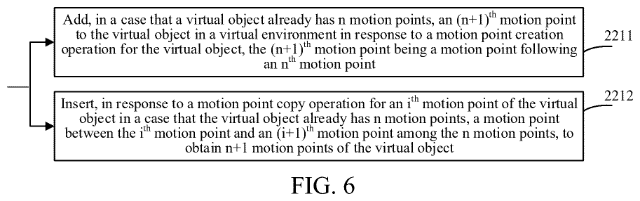

In an aspect based on FIG. 4, as shown in FIG. 6, operation 221 may be alternatively implemented as at least one of operation 2211 or operation 2212.

Operation 2211: Add, in a case that the virtual object already has n motion points, an (n+1)^{th} motion point to the virtual object in the virtual environment in response to a motion point creation operation for the virtual object, the (n+1)^{th} motion point being a motion point following an n^{th} motion point, and n being a positive integer. For example, when the virtual object has n motion points, an (n+1)th motion point following an nth motion point is added based on a new motion point creation operation performed on the motion path of the virtual object, n being a positive integer.

That the (n+1)^{th} motion point is a motion point following an n^{th} motion point means that after the virtual object moves to the n^{th} motion point, a next motion point to which the virtual object needs to move is the (n+1)^{th} motion point.

In some aspects, the motion parameter of the (n+1)^{th} motion point in the virtual environment is the same as that of the n^{th} motion point. Alternatively, the rotation parameter and the scaling parameter of the (n+1)^{th} motion point in the virtual environment are the same as the rotation parameter and the scaling parameter of the n^{th} motion point, and the coordinate parameter of the (n+1)^{th} motion point is a sum of the coordinate parameter of the n^{th} motion point and an offset coordinate parameter. Alternatively, the motion parameter of the (n+1)^{th} motion point in the virtual environment is a preset motion parameter of the virtual object. Alternatively, the rotation parameter and the scaling parameter of the (n+1)^{th} motion point in the virtual environment are a preset rotation parameter and a preset scaling parameter of the virtual object, and the coordinate parameter of the (n+1)^{th} motion point is a sum of the coordinate parameter of the n^{th} motion point and the offset coordinate parameter.

In some aspects, the offset coordinate parameter is a coordinate parameter offset toward a positive semi-axis of the x-axis. Alternatively, the offset coordinate parameter is a coordinate parameter offset toward a negative semi-axis of the x-axis. Alternatively, the offset coordinate parameter is a coordinate parameter offset toward a positive semi-axis of the y-axis. Alternatively, the offset coordinate parameter is a coordinate parameter offset toward a negative semi-axis of the y-axis. Alternatively, the offset coordinate parameter is a coordinate parameter offset to a positive semi-axis of the z-axis. Alternatively, the offset coordinate parameter is a coordinate parameter offset toward a negative semi-axis of the z-axis. Alternatively, the offset coordinate parameter is a coordinate parameter offset toward the positive semi-axis of the x-axis and the positive semi-axis of the y-axis. Alternatively, the offset coordinate parameter is a coordinate parameter offset toward the positive semi-axis of the x-axis and the positive semi-axis of the z-axis. Alternatively, the offset coordinate parameter is a coordinate parameter offset toward the positive semi-axis of the y-axis and the positive semi-axis of the z-axis. Alternatively, the offset coordinate parameter is a coordinate parameter offset toward the positive semi-axis of the x-axis, the positive semi-axis of the y-axis, and the positive semi-axis of the z-axis. In this aspect of this disclosure, only offset directions of some offset coordinate parameters are listed, and offset directions of remaining offset coordinate parameters are not listed one by one in this aspect of this disclosure, but the scope of this disclosure is not limited thereto.

In some aspects, an offset value of the offset coordinate parameter is a preset value. Alternatively, the offset value of the offset coordinate parameter is a value set by a user.

For example, the offset direction of the offset coordinate parameter is offset toward the positive semi-axis of the y-axis, the offset value of the offset coordinate parameter is a preset value of 20, and the offset coordinate parameter is (0, 20, 0). Alternatively, the offset direction of the offset coordinate parameter is offset toward the positive semi-axis of the x-axis and the positive semi-axis of the y-axis, the offset value of the offset coordinate parameter in the x-axis direction is a preset value of 20, an offset value in the y-axis direction is a preset value of 10, and the offset coordinate parameter is (20, 10, 0). Alternatively, the offset direction of the offset coordinate parameter is offset toward the negative semi-axis of the x-axis and the positive semi-axis of the y-axis, the offset value of the offset coordinate parameter in the x-axis direction is a value of 50 set by a user, the offset value in the y-axis direction is a value of 30 set by a user, and the offset coordinate parameter is (−50, 30, 0).

For example, the rotation parameter of the n^{th} motion point is (0, 20, 0), the scaling parameter is (1, 2, 2), and the coordinate parameter is (10, 20, 0). The preset rotation parameter of the virtual object is (0, 0, 0), the preset scaling parameter is (0, 0, 0), and the preset coordinate parameter of the virtual object is (0, 0, 0). The offset coordinate parameter is (0, 20, 0). Then, the rotation parameter of the (n+1)^{th} motion point is the rotation parameter (0, 20, 0) of the n^{th} motion point, the scaling parameter of the (n+1)^{th} motion point is the scaling parameter (1, 2, 2) of the n^{th} motion point, and the coordinate parameter of the (n+1)^{th} motion point is the coordinate parameter (10, 20, 0) of the n^{th} motion point. Alternatively, the rotation parameter of the (n+1)^{th} motion point is the rotation parameter (0, 20, 0) of the n^{th} motion point, the scaling parameter of the (n+1)^{th} motion point is the scaling parameter (1, 2, 2) of the n^{th} motion point, and the coordinate parameter of the (n+1)^{th} motion point is a sum of the coordinate parameter (10, 20, 0) of the n^{th} motion point and the offset coordinate parameter (0, 20, 0). Then the coordinate parameter of the (n+1)^{th} motion point is (10, 40, 0). Alternatively, the rotation parameter of the (n+1)^{th} motion point is the preset rotation parameter (0, 0, 0) of the virtual object, the scaling parameter of the (n+1)^{th} motion point is the preset scaling parameter (0, 0, 0) of the virtual object, and the coordinate parameter of the (n+1)^{th} motion point is the preset coordinate parameter (0, 0, 0) of the virtual object.

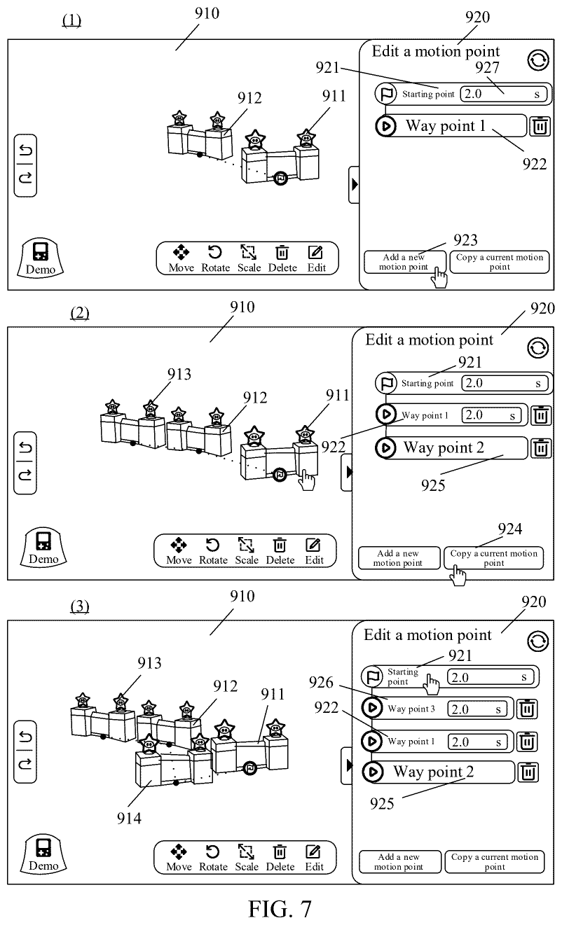

For example, as shown in a schematic diagram (1) in FIG. 7, the editor interface includes at least one of a virtual environment picture 910 and a motion point editing region 920. The virtual environment picture 910 displays two motion points of the virtual object, which are respectively a starting point and a way point 1. The starting point is displayed as a motion point 911 in the virtual environment. The way point 1 is displayed as a motion point 912 in the virtual environment. A coordinate parameter of the motion point 912 is (10, 20, 0). The motion point editing region 920 displays a motion point control 921 of the starting point and a motion point control 922 of the way point 1. After the user taps a new motion point adding control 923 to perform a new motion point adding operation, as shown in a schematic diagram (2), a motion point control 925 of a way point 2 is newly added to the motion point editing region 920, and a motion point 913 is newly added to the virtual environment picture 910. A rotation parameter and a scaling parameter of the motion point 913 are equal to a rotation parameter and a scaling parameter of the motion point 912, an offset coordinate parameter is (0, 20, 0), and a coordinate parameter of the motion point 913 is (10, 40, 0).

Operation 2212: Insert, in response to a motion point copy operation for an i^{th} motion point of the virtual object in a case that the virtual object already has n motion points, a motion point between the i^{th} motion point and an (i+1)^{th} motion point among the n motion points, to obtain n+1 motion points of the virtual object. For example, based on a motion point copy operation performed on the i^{th} motion point when the motion path of the virtual object includes n motion points, a new motion point between the i^{th} motion point and an (i+1)th motion point of the n motion points is inserted to obtain (n+1) motion points. The new motion point is an (i+1)th motion point of the (n+1) motion points, and the (i+1)th motion point of the n motion points is an (i+2)th motion point of the (n+1) motion points, n being a positive integer, and i being a positive integer less than n.

The inserted motion point is an (i+1)^{th} motion point among the n+1 motion points. The (i+1)^{th} motion point among the n motion points is shifted to an (i+2)^{th} motion point among the n+1 motion points, where i is a positive integer less than n.

In some aspects, in response to a motion point copy operation for an n^{th} motion point of the virtual object, a motion point is inserted following the n^{th} motion point, to obtain n+1 motion points of the virtual object.

In some aspects, the rotation parameter and the scaling parameter of the inserted (i+1)^{th} motion point are the same as those of the i^{th} motion point, and the coordinate parameter of the (i+1)^{th} motion point is a sum of the coordinate parameter of the i^{th} motion point and an offset coordinate parameter. Alternatively, the motion parameter of the (i+1)^{th} motion point in the virtual environment is a preset motion parameter of the virtual object. Alternatively, the rotation parameter and the scaling parameter of the (i+1)^{th} motion point in the virtual environment are a preset rotation parameter and a preset scaling parameter of the virtual object, and the coordinate parameter of the (i+1)^{th} motion point is a sum of the coordinate parameter of the i^{th} motion point and the offset coordinate parameter.

Schematically, as shown in a schematic diagram (2) of FIG. 7, there are three motion points in total, namely, a starting point,? a way point 1, and a way point 2, in the editor interface. The starting point is displayed as a motion point 911 in a virtual environment picture 910, the way point 1 is displayed as a motion point 912, and the way point 2 is displayed as a motion point 913. A motion point editing region 920 displays a motion point control 921 of the starting point, a motion point control 922 of the way point 1, and a motion point control 925 of the way point 2. After tapping the motion point control 921 of the starting point, the user further taps a current motion point copy control 924, a newly added motion point 914 is displayed in the virtual environment picture, and a motion point control 926 of a way point 3 is newly added between the starting point and the way point 1 in the way point editing region 920. The rotation parameter and the scaling parameter of the newly added motion point 914 are the same as the rotation parameter and the scaling parameter of the copied motion point 911, and the coordinate parameter of the motion point 914 is a sum of the coordinate parameter of the motion point 911 and the offset coordinate parameter. After the user taps the motion point control 921 of the starting point, the motion point 911 in the virtual environment picture 910 is displayed in a selected state.

In some aspects, operation 2211 may be implemented as an independent aspect, and operation 2212 may be implemented as an independent aspect. Operation 2211 and operation 2212 may be performed in an alternate order or simultaneously.

In conclusion, according to the method provided in this aspect of this disclosure, motion point adding is divided into new motion point adding and motion point copy, a motion parameter of the new motion point adding is a preset value, and a motion parameter of the motion point copy is a motion parameter of a copied motion point. A user may select a manner of adding a motion point according to a requirement, so that an operation is simple and convenient, and a requirement of the user for adding a motion point may be diversified.

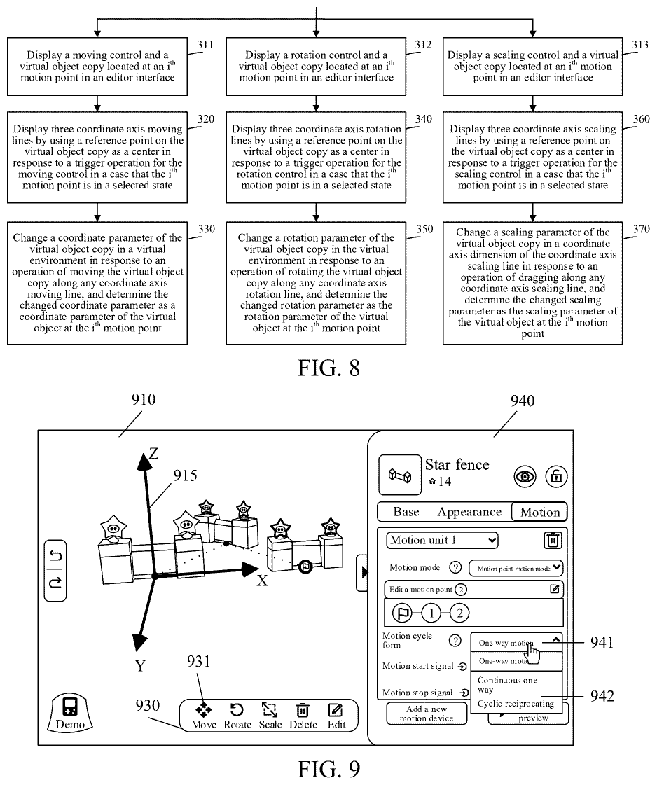

In an aspect based on FIG. 4, as shown in FIG. 8, operation 222 may be alternatively implemented as at least one of operation 310 to operation 370.

Operation 310 includes at least one of the following three operations.

Operation 311: Display a moving control and a virtual object copy located at an i^{th} motion point in the editor interface.

Operation 312: Display a rotation control and a virtual object copy located at an i^{th} motion point in the editor interface.

Operation 313: Display a scaling control and a virtual object copy located at an i^{th} motion point in the editor interface.

For the moving control and the virtual object copy of the i^{th} motion point displayed in operation 311, operation 222 may be alternatively implemented as operation 320 to operation 330.

Operation 320: Display three coordinate axis moving lines by using a reference point on the virtual object copy as a center in response to a trigger operation for the moving control in a case that the i^{th} motion point is in a selected state.

In some aspects, the i^{th} motion point is in a selected state, and the virtual object copy of the i^{th} motion point has a highlighted frame. Alternatively, the i^{th} motion point is in a selected state, and the virtual object copy of the i^{th} motion point has a bold frame.

In some aspects, as shown in FIG. 9, a control display region 930 is displayed in a virtual environment picture 910, and in response to a tap operation for a moving control 931 in the control display region 930, three coordinate axis moving lines 915 are displayed by using a reference point on the virtual object copy as a center.

Operation 330: Change a coordinate parameter of the virtual object copy in the virtual environment in response to an operation of moving the virtual object copy along any coordinate axis moving line, and determine the changed coordinate parameter as the coordinate parameter of the virtual object at the i^{th} motion point.

The coordinate parameter of the virtual object copy in the virtual environment represents three-dimensional coordinates of the virtual object copy in the virtual environment. After the virtual object copy moves along any coordinate axis moving line, the three-dimensional coordinates of the virtual object copy in the virtual environment are changed, so that the coordinate parameter of the virtual object copy in the virtual environment is changed.

In some aspects, the coordinate parameter of the virtual object copy in the virtual environment is relative to a world coordinate system. Alternatively, the coordinate parameter of the virtual object copy in the virtual environment is relative to a first motion point. Alternatively, the coordinate parameter of the virtual object copy in the virtual environment is relative to an (i−1)^{th} motion point.

For example, the coordinate parameter of the virtual object copy in the virtual environment is relative to a world coordinate system, an origin of the world coordinate system is (0, 0, 0), and the coordinate parameter of the virtual object copy of an i^{th} motion point is (10, 0, 20), indicating a position of coordinates (10, 0, 20) of the virtual object copy in the world coordinate system. Alternatively, the coordinate parameter of the virtual object copy in the virtual environment is relative to a first motion point, a position of the first motion point is an origin (0, 0, 0), and the coordinate parameter of the virtual object copy of the i^{th} motion point is (10, 0, 20), indicating a position of coordinates (10, 0, 20) of the virtual object copy in a coordinate system using the position of the first motion point as an origin. Alternatively, the coordinate parameter of the virtual object copy in the virtual environment is relative to an (i−1)^{th} motion point, a position of the (i−1)^{th} motion point is an origin (0, 0, 0), and the coordinate parameter of the virtual object copy of the i^{th} motion point is (10, 0, 20), indicating a position of coordinates (10, 0, 20) of the virtual object copy in a coordinate system using the position of the (i−1)^{th} motion point as an origin.

For the rotation control and the virtual object copy of the i^{th} motion point displayed in operation 312, operation 222 may be alternatively implemented as operation 340 to operation 350.

Operation 340: Display three coordinate axis rotation lines by using a reference point on the virtual object copy as a center in response to a trigger operation for the rotation control in a case that the i^{th} motion point is in a selected state.

In some aspects, the i^{th} motion point is in a selected state, and the virtual object copy of the i^{th} motion point has a highlighted frame. Alternatively, the i^{th} motion point is in a selected state, and the virtual object copy of the i^{th} motion point has a bold frame.

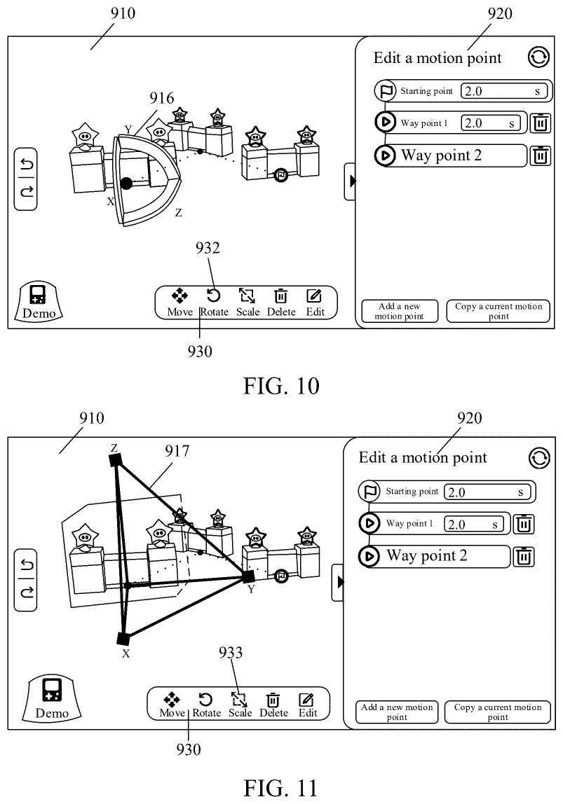

In some aspects, as shown in FIG. 10, a control display region 930 is displayed in a virtual environment picture 910, and in response to a tap operation for a rotation control 932 in the control display region 930, three coordinate axis rotation line 916 are displayed by using a reference point on the virtual object copy as a center.

Operation 350: Change a rotation parameter of the virtual object copy in the virtual environment in response to an operation of rotating the virtual object copy along any coordinate axis rotation line, and determine the changed rotation parameter as the rotation parameter of the virtual object at the i^{th} motion point.

The rotation parameter of the virtual object copy in the virtual environment represents a rotation posture of the virtual object copy in the virtual environment. After the virtual object copy is rotated along any coordinate axis moving line, the rotation posture of the virtual object copy in the virtual environment is changed, so that the rotation parameter of the virtual object copy in the virtual environment is changed.

In some aspects, the rotation parameter of the virtual object copy in the virtual environment is relative to a world coordinate system. Alternatively, the rotation parameter of the virtual object copy in the virtual environment is relative to a first motion point. Alternatively, the rotation parameter of the virtual object copy in the virtual environment is relative to an (i−1)^{th} motion point.

For example, the rotation parameter of the virtual object copy in the virtual environment is relative to a world coordinate system, an origin of the world coordinate system is (0°, 0°, 0°), and the rotation parameter of the virtual object copy of the i^{th} motion point is (10°, 0°, 20°), indicating that the virtual object copy deflects by 10 degrees relative to a plane corresponding to the x-axis, deflects by 0 degrees relative to a plane corresponding to the y-axis, and deflects by 20 degrees relative to a plane corresponding to the z-axis in the world coordinate system. Alternatively, the rotation parameter of the virtual object copy in the virtual environment is relative to the first motion point, the rotation parameter of the first motion point is an origin (0°, 0°, 0°), and the rotation parameter of the virtual object copy of the i^{th} motion point is (10°, 0°, 20°), indicating that the virtual object copy deflects by 10 degrees relative to the plane corresponding to the x-axis, deflects by 0 degrees relative to the plane corresponding to the y-axis, and deflects by 20 degrees relative to the plane corresponding to the z-axis in a coordinate system using the rotation parameter of the first motion point as an origin. Alternatively, the rotation parameter of the virtual object copy in the virtual environment is relative to the (i−1)^{th} motion point, the rotation parameter of the (i−1)^{th} motion point is an origin (0°, 0°, 0°), and the rotation parameter of the virtual object copy of the i^{th} motion point is (10°, 0°, 20°), indicating that the virtual object copy deflects by 10 degrees relative to the plane corresponding to the x-axis, deflects by 0 degrees relative to the plane corresponding to the y-axis, and deflects by 20 degrees relative to the plane corresponding to the z-axis in a coordinate system using the rotation parameter of the (i−1)^{th} motion point as an origin.

For the scaling control and the virtual object copy of the i^{th} motion point displayed in operation 313, operation 222 may be alternatively implemented as operation 360 to operation 370.

Operation 360: Display three coordinate axis scaling lines by using a reference point on the virtual object copy as a center in response to a trigger operation for the scaling control in a case that the i^{th} motion point is in a selected state.

In some aspects, the i^{th} motion point is in a selected state, and the virtual object copy of the i^{th} motion point has a highlighted frame. Alternatively, the i^{th} motion point is in a selected state, and the virtual object copy of the i^{th} motion point has a bold frame.

In some aspects, as shown in FIG. 11, a control display region 930 is displayed in a virtual environment picture 910, and in response to a tap operation for a scaling control 933 in the control display region 930, three coordinate axis scaling lines 917 are displayed by using a reference point on the virtual object copy as a center.

Operation 370: Change, in response to an operation of dragging along any coordinate axis scaling line, a scaling parameter of the virtual object copy in a coordinate axis dimension of the coordinate axis scaling line, and determine the changed scaling parameter as the scaling parameter of the virtual object at the i^{th} motion point.

The scaling parameter of the virtual object copy in the virtual environment represents a scaling ratio of the virtual object copy in the virtual environment. After the operation of dragging along any coordinate axis scaling line is performed, the scaling ratio of the virtual object copy in the virtual environment is changed, so that the scaling parameter of the virtual object copy in the virtual environment is changed.

In some aspects, the scaling parameter of the virtual object copy in a coordinate axis dimension of the coordinate axis scaling line is relative to the first motion point. Alternatively, the scaling parameter of the virtual object copy in the coordinate axis dimension of the coordinate axis scaling line is relative to the (i−1)^{th} motion point.

For example, there are three coordinate axis scaling lines, namely, an x-axis, a y-axis, and a z-axis, and the three scaling lines respectively correspond to a length direction, a width direction, and a height direction of the virtual object. The scaling parameter of the virtual object copy in the coordinate axis dimension corresponding to the coordinate axis scaling line is relative to the first motion point, the scaling parameter of the first motion point is (1, 1, 1), and the scaling parameter of the virtual object copy of the i^{th} motion point is (1, 0.8, −2), indicating that the virtual object copy is 1 time the length of the first motion point in the positive semi-axis direction of the x axis, 0.8 time the width of the first motion point in the positive semi-axis direction of the y axis, and 2 times the length of the first motion point in the negative semi-axis direction of the z axis. Alternatively, the scaling parameter of the virtual object copy in the coordinate axis dimension corresponding to the coordinate axis scaling line is relative to the (i−1)^{th} motion point, the scaling parameter of the (i−1)^{th} motion point is (1, 1, 1), and the scaling parameter of the virtual object copy of the i^{th} motion point is (1, 0.8, −2), indicating that the virtual object copy is 1 time the length of the (i−1)^{th} motion point in the positive semi-axis direction of the x axis, 0.8 times the width of the (i−1)^{th} motion point in the positive semi-axis direction of the y axis, and 2 times the length of the (i−1)^{th} motion point in the negative semi-axis direction of the z axis.

In conclusion, according to the method provided in this aspect of this disclosure, motion point editing is divided into a moving operation, a rotation operation, and a scaling operation. A virtual object copy at a motion point is moved to adjust a coordinate parameter of the motion point. The virtual object copy at the motion point is rotated to adjust a rotation parameter of the motion point. The virtual object copy at the motion point is scaled to adjust a scaling parameter of the motion point. A motion parameter of an object moving to the motion point is changed through these editing operations, so that a motion of a virtual object in a virtual scenario is more diversified.

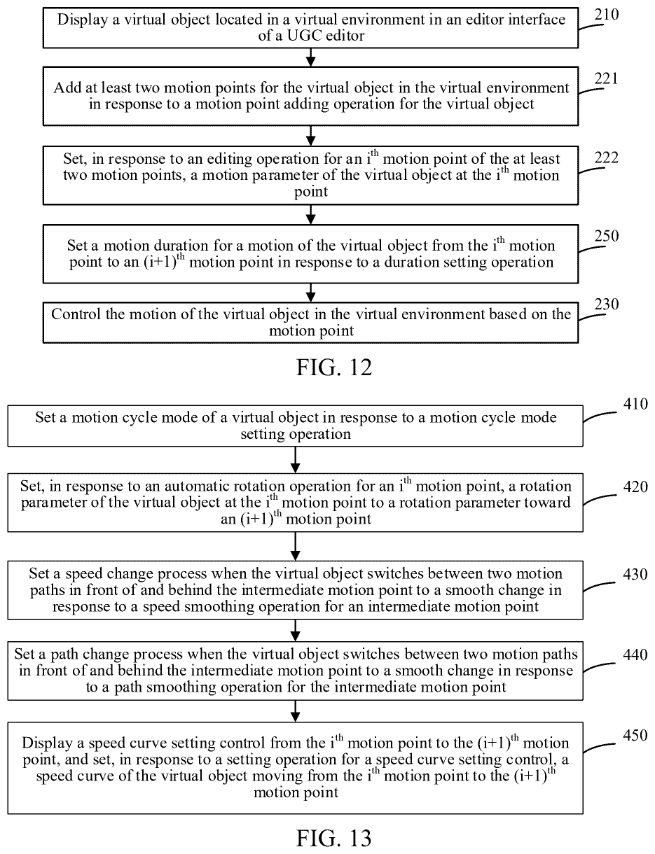

In an aspect based on FIG. 4, as shown in FIG. 12, the method further includes operation 250.

Operation 250: Set a motion duration for a motion of the virtual object from the i^{th} motion point to the (i+1)^{th} motion point in response to a duration setting operation. For example, when the at least two motion points include the i^{th} motion point and an (i+1)th motion point, based on a motion duration setting operation performed on the virtual object, a motion duration for movement of the virtual object from the i^{th} motion point to the (i+1)th motion point is set, i being a positive integer.

In some aspects, the motion duration is preset by the UGC editor. Alternatively, the motion duration is set by a user.

For example, the motion duration, preset by the UGC editor, for the motion of the virtual object from the i^{th} motion point to the (i+1)^{th} motion point is 2 s. Alternatively, the user performs the duration setting operation, and the motion duration for the motion of the virtual object from the i^{th} motion point to the (i+1)^{th} motion point is 0.8 s.

In some aspects, in response to an editing operation for the i^{th} motion point, a motion point control of the i^{th} motion point is displayed on the editor interface. A duration input box is displayed on the motion point control of the i^{th} motion point.

For example, as shown in a schematic diagram (1) of FIG. 7, a motion point editing region 920 is displayed in the editor interface. A motion point control 921 of a starting point and a motion point control 922 of a way point 1 are displayed in the motion point editing region 920. A duration input box 927 is displayed on the motion point control 921 of the starting point, and is configured for inputting a motion duration for a motion from the starting point to the way point 1.

In some aspects, in response to an operation of inputting a duration in the duration input box, the motion duration for the motion of the virtual object from the i^{th} motion point to the (i+1)^{th} motion point is set as an inputted duration.

For example, the user enters 0.8 in the duration input box displayed on the motion point control of the i^{th} motion point, and then a duration for the motion of the virtual object from the i^{th} motion point to the (i+1)^{th} motion point is set to 0.8 s.

In conclusion, according to the method provided in this disclosure, a motion speed of a virtual object between two motion points is controlled by setting a motion duration, so that a user can more intuitively feel the motion duration and a speed state of the virtual object in a virtual environment, and the motion speed of the virtual object can be changed by modifying the motion duration.

In an aspect based on FIG. 4, as shown in FIG. 13, the method further includes at least one of operation 410 to operation 450.

Operation 410: Set a motion cycle mode of the virtual object in response to a motion cycle mode setting operation. For example, based on a motion cycle mode setting operation, a motion cycle mode of the virtual object is set.

The motion cycle mode includes at least one of a one-way motion manner, a continuous one-way manner, or a cyclic reciprocating manner. The one-way motion manner is a manner of sequentially moving from a first motion point to a last motion point. The continuous one-way manner is a continuous motion manner of sequentially moving from the first motion point to the last motion point again after sequentially moving from the first motion point to the last motion point. The cyclic reciprocating manner is a reciprocating motion manner of sequentially moving from the first motion point to the last motion point, and then returning from the last motion point to a previous motion point until moving back to the first motion point.

For example, as shown in FIG. 9, a virtual object details region 940 is displayed in the editor interface. A motion cycle mode setting control 941 is displayed in the virtual object details region 940. After the motion cycle mode setting control 941 is tapped, a drop-down bar 942 is displayed. The drop-down bar is configured for displaying a motion cycle mode.

Operation 420: Set a rotation parameter of the virtual object at the i^{th} motion point to a rotation parameter toward the (i+1)^{th} motion point in response to an automatic rotation operation for the i^{th} motion point. For example, when the at least two motion points include the ith motion point and an (i+1)^{th} motion point, based on an automatic rotation operation performed on the i^{th} motion point, the rotation parameter of the virtual object at the i^{th} motion point is set to a rotation parameter oriented toward the (i+1)^{th} motion point, i being a positive integer.

For example, the rotation parameter at the i^{th} motion point is (0°, 20°, 20°), and the rotation parameter of the virtual object toward the (i+1)^{th} motion point is (50°, 10°, 0°). In response to an automatic rotation operation for the i^{th} motion point, the rotation parameter of the virtual object at the i^{th} motion point is set to the rotation parameter (50°, 10°, 0°) toward the (i+1)^{th} motion point.

Operation 430: Set a speed change process when the virtual object switches between two motion paths in front of and behind the intermediate motion point to a smooth change in response to a speed smoothing operation for the intermediate motion point. For example, based on a speed smoothing operation performed on an intermediate motion point located between a first motion point and a last motion point, a gradual transition of speed between motion path segments before and after the intermediate motion point is set.

For example, there are three motion points. A motion duration of the first motion point is 2 s, and a motion duration of the second motion point is 8 s. A shortest distance between the first motion point and the second motion point is 2 m, and a shortest distance between the second motion point and the third motion point is 2 m. When a speed smoothing operation is not performed on the second motion point, the virtual object moves from the first motion point to the second motion point at a speed of 1 m/s. When the virtual object starts to move from the second motion point to the third motion point, the speed will suddenly change to 0.25 m/s. After the speed smoothing operation is performed on the second motion point, when the virtual object moves from the first motion point to the second motion point: at the 1st second, the speed is 1 m/s; and at the 2nd second, the speed is 0.5 m/s. When the virtual object moves from the second motion point to the third motion point: at the 1st second, the speed is 0.25 m/s.

Operation 440: Set a path change process when the virtual object switches between two motion paths in front of and behind the intermediate motion point to a smooth change in response to a path smoothing operation for the intermediate motion point. For example, based on a path smoothing operation performed on an intermediate motion point located between a first motion point and a last motion point, a gradual transition path segment between motion path segments before and after the intermediate motion point is set.

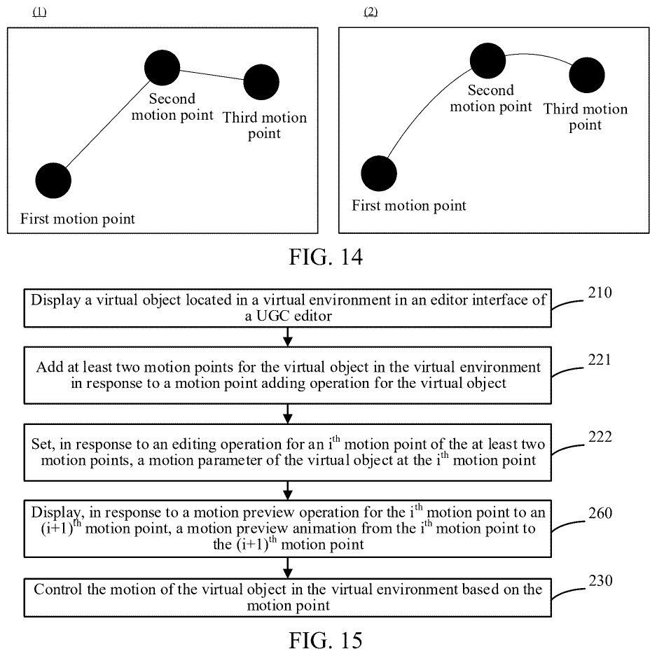

For example, as shown in FIG. 14, there are three motion points, and positions of the three motion points are shown in a schematic diagram (1) and a schematic diagram (2). When a path smoothing operation is not performed on the second motion point, as shown in the schematic diagram (1), the virtual object moves from the first motion point to the second motion point, and moves from the second motion point to the third motion point along a straight line between the two motion points (i.e., a shortest path between the two motion points). After a path smoothing operation is performed on the second motion point, as shown in the schematic diagram (2), the virtual object moves from the first motion point to the second motion point and moves from the second motion point to the third motion point along a curve.

Operation 450: Display a speed curve setting control from the i^{th} motion point to the (i+1)^{th} motion point, and set a speed curve of the virtual object moving from the i^{th} motion point to the (i+1)^{th} motion point in response to a setting operation for the speed curve setting control, i being a positive integer. For example, when the at least two motion points include the i^{th} motion point and an (i+1)^{th} motion point, in the editor interface, a speed curve setting control element for movement from the i^{th} motion point to the (i+1)^{th} motion point is output for display. Based on a setting operation performed on the speed curve setting control element, a speed curve of the virtual object moving from the i^{th} motion point to the (i+1)^{th} motion point is set, i being a positive integer.

In some aspects, the editor interface displays a speed curve setting control from the i^{th} motion point to the (i+1)^{th} motion point.

In some aspects, the speed curve is a curve formula inputted by a user. Alternatively, the speed curve is a curve obtained by the user by performing adjustment based on a speed curve provided by the UGC editor, and the speed curve is represented by a curve formula.

For example, there are two motion points, a motion duration of the first motion point is 2 s, and a distance between the first motion point and the second motion point is 2 m. The speed curve set by the user is y=x+0.5. An initial speed of the virtual object when moving from the first motion point to the second motion point is 0.5 m/s, the speed is 1.5 m/s at the 1st second of the motion from first motion point to the second motion point, and the speed is 2.5 m/s at the 2nd second of the motion from first motion point to the second motion point.

In some aspects, in response to an operation of setting a motion start signal, a start signal for starting the virtual object to move is set.

In some aspects, the start signal indicates that the coordinate parameter of the virtual object reaches a preset value. Alternatively, the start signal indicates that the rotation parameter of the virtual object reaches a preset value. Alternatively, the start signal indicates that the scaling ratio of the virtual object reaches a preset value. Alternatively, the start signal is a fixed time, where the fixed time is a preset value, or the fixed time is set by a user.

For example, the start signal indicates that the coordinate parameter of the virtual object falls within a range A. Then, when the coordinate parameter of the virtual object falls within the range A, the virtual object starts to move. Alternatively, the start signal indicates that a duration for which the virtual object appears in the virtual environment picture reaches 2 s. Then, when the duration for which the virtual object appears in the virtual environment picture reaches 2 s, the virtual object starts to move.

In some aspects, in response to an operation of setting a motion stop signal, a stop signal for stopping the virtual object from moving is set.

In some aspects, the stop signal indicates that the coordinate parameter of the virtual object reaches a preset value. Alternatively, the stop signal indicates that the rotation parameter of the virtual object reaches a preset value. Alternatively, the stop signal indicates that the scaling ratio of the virtual object reaches a preset value. Alternatively, the stop signal is a fixed time, where the fixed time is a preset value, or the fixed time is set by a user.

In some aspects, operation 410, operation 420, operation 430, operation 440, and operation 450 are alternative. In different aspects, one or more of these operations may be omitted or replaced, and operation 410, operation 420, operation 430, operation 440, and operation 450 may be performed in an alternate order or simultaneously.

Operation 410 may be implemented as an independent aspect. Operation 420 may be implemented as an independent aspect. Operation 430 may be implemented as an independent aspect. Operation 440 may be implemented as an independent aspect. Operation 450 may be implemented as an independent aspect. Operation 410 and operation 420 may be implemented as independent aspects. Operation 420 and operation 430 may be implemented as independent aspects. Operation 430 and operation 440 may be implemented as independent aspects. Operation 410, operation 420, and operation 430 may be implemented as independent aspects. Operation 410, operation 420, operation 430, and operation 440 may be implemented as independent aspects. However, this disclosure is not limited thereto.

In conclusion, the method provided in this aspect of this disclosure provides a plurality of motion point setting operations for a user. The user can set motion points only by performing trigger operations on different setting controls, and these settings can control a motion of a virtual object in a virtual environment to be more natural and kinematic. These settings can be implemented only by the simple trigger operations, so that the user can quickly implement a complete logical motion of the virtual object in the virtual environment.

In an aspect based on FIG. 4, as shown in FIG. 15, the method further includes operation 260.

Operation 260: Display a motion preview animation from the i^{th} motion point to the (i+1)^{th} motion point in response to a motion preview operation for the i^{th} motion point to the (i+1)^{th} motion point. For example, when the at least two motion points include the i^{th} motion point and an (i+1)^{th} motion point, a motion preview animation from the i^{th} motion point to the (i+1)^{th} motion point is output for display based on a motion preview operation performed on the i^{th} motion point.

When rotation parameters of the i^{th} motion point and the (i+1)^{th} motion point are different, the motion preview animation displays a gradient rotation motion of a shortest rotation path changing from the rotation parameter of the i^{th} motion point to the rotation parameter of the (i+1)^{th} motion point. When scaling parameters of the i^{th} motion point and the (i+1)^{th} motion point are different, the motion preview animation displays a gradient scaling motion changing from the scaling parameter of the i^{th} motion point to a shortest scaling path of the scaling parameter of the (i+1)^{th} motion point.

In some aspects, a motion preview control for the at least two motion points is displayed on the editor interface, and the at least two motion points include n motion points.

In some aspects, in response to a trigger operation for a motion preview control of the i^{th} motion point, a motion preview animation from the i^{th} motion point to the n^{th} motion point is displayed, where n is a positive integer, and i is a positive integer less than n.

In conclusion, the method provided in this aspect of this disclosure supports a user to preview a motion, which makes it convenient for the user to understand a motion process, and realizes WYSIWYG, thereby improving enthusiasm of the user for use.

To understand various display manners and operation manners in the aspects of this disclosure, detailed descriptions are made below with reference to schematic diagrams. A motion point is a way point, or referred to as a position point, namely a space point on a motion path of a virtual object in a virtual environment.

### Display a Virtual Object Located in a Virtual Environment in an Editor Interface of a UGC Editor

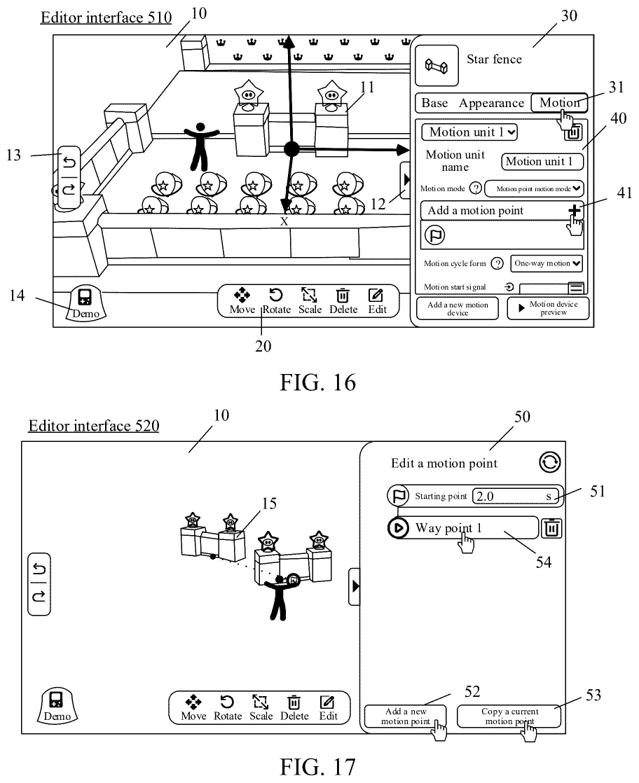

As shown in FIG. 16, an editor interface 510 includes at least one of a virtual environment picture 10 and a control display region 20. A virtual object 11 located in a virtual environment is displayed in the virtual environment picture 10.

The virtual environment picture 10 is a picture obtained by collecting a three-dimensional virtual environment using a camera model. A user may control the camera model by using an interactive operation on a touchscreen to change a display effect of the virtual environment picture 10. The control display region 20 is configured for displaying controls for editing the virtual object, including at least one of a moving control, a rotation control, a scaling control, a deletion control, and an editing control.

When the user selects the virtual object 11 by using the editor interface 510, a virtual object details region 30 is displayed in a right region of the editor interface 510. Alternatively, when the user selects the virtual object 11 and after a tap operation is performed on the editing control in the control display region 20, the virtual object details region 30 is displayed in the right region of the editor interface 510. After the user performs a tap operation on a motion information viewing control 31 in the virtual object details region 30, the virtual object details region 30 displays a motion control region 40.

The editor interface 510 further includes a virtual object details hiding control 12. The virtual object details region 30 may be hidden from the editor interface 510 based on a tap operation of the user on the virtual object details hiding control 12.

The virtual object details region 30 is configured for displaying at least one interactive control related to the virtual object. As shown in FIG. 16, the virtual object details region 30 includes a virtual object name display region, a virtual object thumbnail display region, and a virtual object control region. The virtual object control region is configured for displaying controls related to at least one virtual object, including at least one of a basic information viewing control, an appearance information viewing control, and a motion information viewing control 31.

Other display manners of the motion control region 40 further include: when the user selects the virtual object 11, the motion control region 40 is displayed in the right region of the editor interface 510. Alternatively, when the user selects the virtual object 11 and after a tap operation is performed on the editing control in the control display region 20, the motion control region 40 is displayed in the right region of the editor interface 510.

The virtual object details region 30 covers a first region of the virtual environment picture 10. Alternatively, the motion control region 40 covers a first region of a portion of the virtual environment picture 10. The first region is one fourth of the editor interface 510.

The motion control region 40 is configured for displaying at least one control related to a motion unit. The motion unit is a component of a motion process of the virtual object, and the user controls, by adding a motion device to the virtual object, the virtual object to move in the virtual environment. The motion device controls the motion process of the virtual object. A plurality of motion devices may be disposed for one virtual object, and one motion device may include a plurality of motion units. The motion unit may be set to different motion modes.

As shown in FIG. 16, the virtual object 11 creates a motion unit named a motion unit 1, and a motion mode of the motion unit 1 is a motion point motion mode. When the motion mode of the motion unit 1 is set to the motion point motion mode, a first motion point is generated according to a coordinate parameter, a rotation parameter, and a scaling parameter of the virtual object 11 in the virtual environment.

The first generated motion point is a starting point, and the starting point has a starting point identifier. For example, the starting point identifier is a flag. Alternatively, the starting point identifier is a highlighted simple shape. Alternatively, the starting point identifier is an icon.

The motion point is configured for indicating a motion parameter of the virtual object on a motion path of the virtual environment. The motion parameter includes at least one of a coordinate parameter, a rotation parameter, and a scaling parameter. The coordinate parameter represents three-dimensional coordinates of the virtual object in the virtual environment. The rotation parameter represents a rotation posture of the virtual object in the virtual environment. The scaling parameter represents a scaling ratio of the virtual object in the virtual environment. The user may perform a same editing operation on the motion point as that on the virtual object. The editing operation may be performed by using a control in the control display region 20. The motion point motion mode supports the user to disassemble the motion path of the virtual object in the virtual environment into a plurality of consecutive motions. Each motion corresponds to at least two motion points. The motion point is displayed in a form of a virtual object copy, and a black sphere is displayed at a reference point of the virtual object copy.

The editor interface 510 further includes a state control region 13 and a demo control 14. The state control region 13 includes a cancel control and a restoration control. The cancel control is configured for canceling an editing operation performed by the user on the virtual object or the motion point. The restoration control is configured for restoring a cancel operation performed by the user on the virtual object or the motion point. The demo control 14 is configured for enabling the user to exit the editor interface, and enter a demo interface. In the demo interface, the virtual object provided with the motion device moves, and the user may enter the demo interface by using the demo control 14 to preview the motion of the virtual object.

### Add a Motion Point

There are two manners of adding a motion point. The first manner is adding a new motion point. The second manner is copying a motion point.

### Manner 1: Add a New Motion Point

As shown in FIG. 16, a user adds a new motion point by performing a tap operation on a new motion point adding control 41 in the motion control region 40. After the user performs the tap operation on the new motion point adding control 41 in the motion control region 40, as shown in FIG. 17, an editor interface 520 displays a motion point editing region 50, and a new motion point 15 appears in a virtual environment picture 10. The new motion point is in a selected state and has a highlighted frame. The motion point editing region 50 is configured for displaying a motion point list. The motion point list displays two motion point controls, which respectively correspond to a starting point and a way point 1. A duration input box 51 is displayed on the motion point control of the starting point. The duration input box 51 is configured for inputting a motion time of moving from a current motion point to a next motion point. A motion duration displayed in the duration input box 51 is 2 s by default, and the user may set, by using the duration input box 51, a motion duration of moving from the current motion point to the next motion point.

As shown in FIG. 17, the user adds a new motion point by performing a tap operation on a new motion point adding control 52 in the motion point editing region 50. The motion point list displays a motion point control 54 of a new motion point. A new motion point 15 appears in the virtual environment image 10. The new motion point is in a selected state and has a highlighted frame. A duration input box 51 is displayed on a motion point control of a starting point. A motion duration displayed in the duration input box 51 is 2 s by default, and the user may set, by using the duration input box 51, a motion duration of moving from the current motion point to the next motion point.

A rotation parameter and a scaling parameter of a way point 1 are the same as a rotation parameter and a scaling parameter of a last way point in the motion point list. A coordinate parameter of the way point 1 is a coordinate parameter obtained after the coordinate parameter of the last way point in the motion point list is moved leftward by one unit. The last way point is a motion point newly added at this time.

After a new motion point is added, in addition to displaying the new motion point, a motion connection line between the motion points is further displayed in the virtual environment picture 10. The motion connection line displays a shortest distance between the two motion points. The motion connection line is shown by using a dashed line.

### Manner 2: Copy a Motion Point

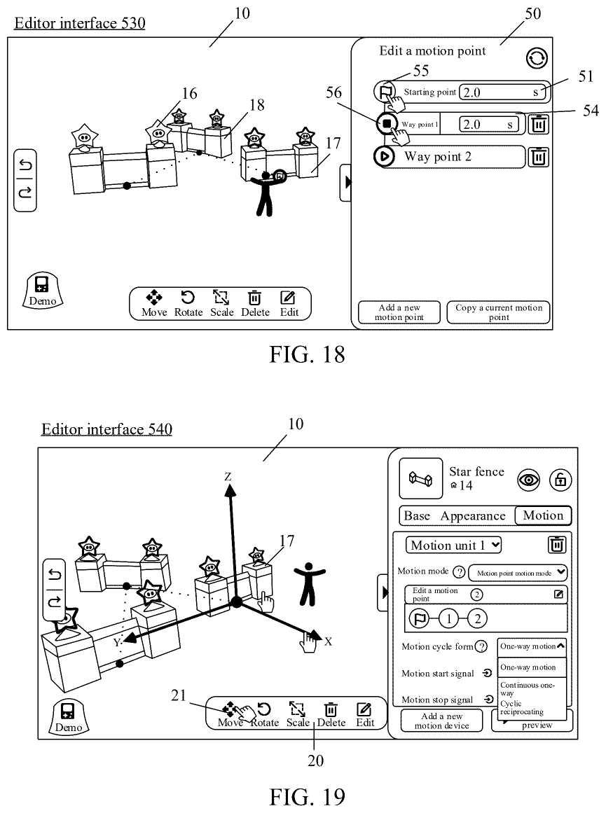

As shown in FIG. 17, a user taps the motion point control 54 of the way point 1 in the motion point editing region 50. The motion point control 54 of the way point 1 is displayed in a selected state and has a highlighted frame. Then, a motion point copy control 53 is tapped, as shown in FIG. 18, a new motion point control is displayed in a motion point list, a new motion point 16 appears in a virtual environment picture 10, and the new motion point is in a selected state and has a highlighted frame. A duration input box is displayed on the motion point control 54 of a motion point 1. A motion duration displayed in the duration input box is 2 s by default, and the user may set, by using the duration input box, a motion duration of moving from the current motion point to the next motion point.

In addition to adding a new motion point and copying a motion point, the motion point editing region 50 can further delete any motion point except the starting point, that is, delete any way point except the starting point. A motion point deletion control is displayed on a right side of the motion point control.

### Edit a Motion Point

There are three editing operations for a motion point: a moving operation, a rotation operation, and a scaling operation.

### 1. Moving Operation

As shown in FIG. 19, after a user taps a motion point 17 in a virtual environment picture 10, the motion point 17 is in a selected state and has a highlighted frame. When the motion point 17 is in a selected state, after the user taps a moving control 21 in a control display region 20, three coordinate axis moving lines, which are respectively an x-axis moving line, a y-axis moving line, and a z-axis moving line, are displayed by using a black sphere of the motion point 17 as a center. After tapping the x-axis moving line, the user may control the motion point 17 to move on the x-axis moving line and an extension line thereof, and the movement changes a coordinate parameter of the motion point 17.

### 2. Rotation Operation

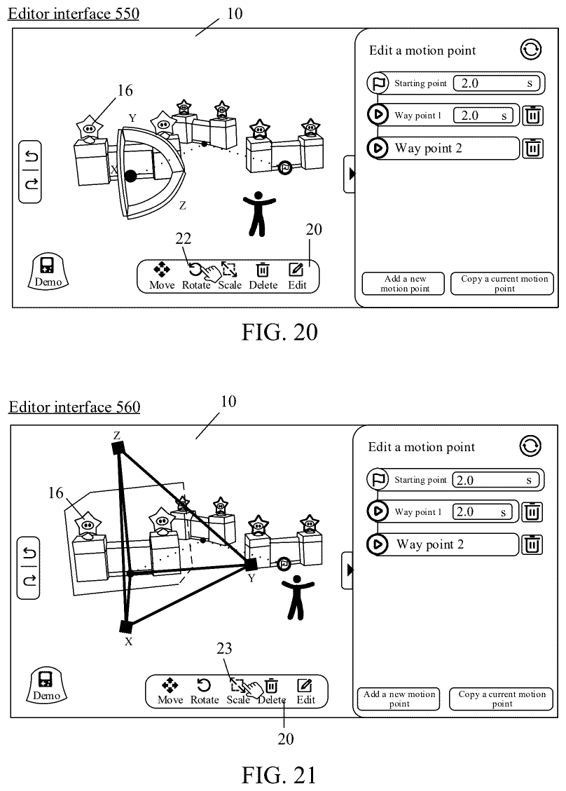

As shown in FIG. 20, after a user taps a motion point 16 in a virtual environment picture 10, the motion point 16 is in a selected state and has a highlighted frame. When the motion point 16 is in a selected state, after the user taps a rotation control 22 in a control display region 20, three coordinate axis rotation lines, which are respectively an x-axis rotation line, a y-axis rotation line, and a z-axis rotation line, are displayed by using a black sphere of the motion point 16 as a center. After tapping the y-axis rotation line, the user may control the motion point 16 to rotate on a plane where the y-axis rotation line is located, and the rotation changes a rotation parameter of the motion point 16.

### 3. Scaling Operation

As shown in FIG. 21, after a user taps a motion point 16 in a virtual environment picture 10, the motion point 16 is in a selected state and has a highlighted frame. When the motion point 16 is in a selected state, after the user taps a scaling control 23 of a control display region 20, three coordinate axis scaling lines, which are respectively an x-axis scaling line, a y-axis scaling line, and a z-axis scaling line, are displayed by using a black sphere of the motion point 16 as a center. The three scaling lines respectively correspond to a length direction, a width direction, and a height direction of a virtual object. Meanwhile, a translucent cuboid that wraps the motion point 16 is further displayed. A length, width, and height of the cuboid are equal to the length, width, and height of the virtual object 11 at the motion point 16. After tapping the z-axis scaling line, the user may control the motion point 16 to be scaled in the z-axis scaling line, namely a height direction, and the scaling changes a scaling parameter of the motion point 16.

### Motion Preview

As shown in FIG. 18, a user taps a motion preview control 55 displayed on a motion point control of a starting point of a motion point editing region 50, and a motion animation in which a virtual object 11 moves from a motion point 17 (i.e., the starting point) to a motion point 18 (i.e., a way point 1) and then to a motion point 16 (i.e., a way point 2) is displayed in a virtual environment picture 10. In a process of playing the motion animation, a motion parameter of the virtual object is gradually changed from a motion parameter of a previous motion point to a motion parameter of a next motion point. For example, when the virtual object 11 moves from the motion point 17 to the motion point 18, a rotation parameter of the motion point 17 is (0°, 0°, 0°), a rotation parameter of the motion point 18 is (0°, 0°, 30°), and a motion time is 2 s. Then, a rotation parameter of the virtual object 11 at the 1st second is (0°, 0°, 15°). The motion of the motion point is a uniform rectilinear motion of a closest distance.

In a process of playing the motion animation moving from the motion point 18 to the motion point 16, a progress bar of animation playback is displayed on a motion point control 54 of the motion point editing region 50, and a motion preview control on the motion point control 54 of the current motion point is changed to a motion stop control 56.

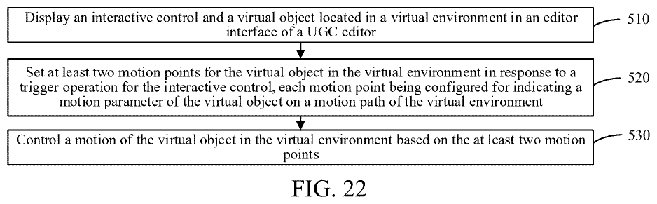

FIG. 22 shows a schematic diagram of a method for generating UGC in a game program according to an aspect of this disclosure. The method includes the following operations.

Operation 510: Display an interactive control and a virtual object located in a virtual environment in an editor interface of a UGC editor.

In some aspects, the interactive control includes at least one of the following controls:

(1) a new motion point adding control, for adding a new motion point; (2) a motion point copy control, for copying a motion point; (3) a moving control, for moving the motion point, and changing a coordinate parameter of the motion point; (4) a rotation control, for rotating the motion point, and changing a rotation parameter of the motion point; (5) a scaling control, for scaling the motion point, and changing a scaling parameter of the motion point; (6) a motion point control, where a duration input box is displayed on the motion point control and is configured for changing a motion duration of the motion point; (7) a motion cycle mode control, for changing a motion cycle mode of the virtual object; (8) an automatic rotation control, for enabling the virtual object to automatically rotate at the motion point; (9) a speed smoothing control, for enabling the virtual object to keep a speed smooth when the speed is switched; (10) a path smoothing control, for enabling the virtual object to keep a path smooth when the path is switched; (11) a speed curve setting control, for setting a speed curve of the virtual object between two motion points; and (12) a motion preview control, for previewing a motion animation of the virtual object.

In some aspects, the interactive control is directly loaded and displayed on the editor interface. Alternatively, the interactive control is loaded and displayed on the editor interface after a terminal triggers a control display event.

For example, after the user taps a display control by using a touchscreen, the terminal transmits obtained tap coordinates to an operating system. The operating system transmits the tap coordinates to a game program. The game program positions a tapped position as the display control according to the tap coordinates. The game program triggers a control display event, and displays at least one of the foregoing interactive controls on the editor interface according to the display control.

Operation 520: Set at least two motion points for the virtual object in the virtual environment in response to a trigger operation for the interactive control, each motion point being configured for indicating a motion parameter of the virtual object on a motion path of the virtual environment.

In some aspects, a motion parameter of a motion point may be abstracted as motion point data. The motion point data includes at least one of a motion parameter, a motion duration, or a setting parameter.

In some aspects, the motion point data is relative to a world coordinate system. Alternatively, the motion point data is relative to a relative coordinate system, for example, relative to a first motion point or relative to a previous motion point.

For example, if the motion point data is relative to the world coordinate system, three coordinate axes of the motion point are in same directions with three coordinate axes of the world coordinate system. When the user performs a rotation operation and a scaling operation on the motion point, the corresponding three coordinate axes are not changed. Alternatively, the motion point data is relative to the relative coordinate system, and then the three coordinates axes of the motion point are correspondingly rotated and scaled according to the rotation operation and the scaling operation performed by the user.

In some aspects, in response to a trigger operation for a new motion point adding control, in a case that the virtual object already has n motion points, an (n+1)^{th} motion point is added to the virtual object in the virtual environment, where the (n+1)^{th} motion point is a motion point following an n^{th} motion point.

For example, after the user performs the trigger operation on the new motion point adding control, the game program generates motion unit data and transmits the motion unit data to a terminal by using an operating system. The terminal transmits the motion unit data to a server, and the server stores the motion unit data in a database. Alternatively, after the user performs the trigger operation on the new motion point adding control, the game program generates motion point data, and transmits the motion point data to the terminal by using the operating system, and the terminal stores the motion point data in a memory. The terminal periodically transmits the motion point data stored in the memory to the server, and the server stores the motion point data in the database.

In some aspects, in response to a trigger operation for the motion point copy control, in response to a motion point copy operation for an i^{th} motion point of the virtual object in a case that the virtual object already has n motion points, a motion point is inserted between the i^{th} motion point and an (i+1)^{th} motion point among the n motion points, to obtain n+1 motion points of the virtual object. The inserted motion point is an (i+1)^{th} motion point among the n+1 motion points. The (i+1)^{th} motion point among the n motion points is shifted to an (i+2)^{th} motion point among the n+1 motion points, where i is a positive integer less than n.

For example, after the user performs the trigger operation on the motion point copy control, the game program generates motion point data, transmits the motion point data to a terminal by using an operating system, and then transmits the motion point data to a server by using the terminal. The server stores the motion point data in a database. Alternatively, after the user performs the trigger operation on the new motion point adding control, the game program generates motion point data, and transmits the motion point data to the terminal by using the operating system, and the terminal stores the motion point data in a memory. The terminal periodically transmits the motion point data stored in the memory to the server, and the server stores the motion point data in the database.

In some aspects, three coordinate axis moving lines are displayed by using a reference point on the virtual object copy as a center in response to a trigger operation for the moving control in a case that the i^{th} motion point is in a selected state. A coordinate parameter of the virtual object copy in the virtual environment is changed in response to an operation of moving the virtual object copy along any coordinate axis moving line, and the changed coordinate parameter (three-dimensional coordinates) is determined as the coordinate parameter of the virtual object at the i^{th} motion point.

For example, the trigger operation performed by the user on the moving control by using the touchscreen triggers a coordinate axis drawing event, so that a display interface of an editor displays three coordinate axis moving lines. An operation performed by the user for moving any coordinate axis moving line among the three coordinate axis moving lines may trigger a coordinate axis event. According to a swiping operation performed by the user on the touchscreen, the terminal obtains coordinates of a pressing point and coordinates of a raising point of the swiping operation, to calculate a swiping distance. The game program triggers the coordinate axis event according to the swiping distance obtained from the operating system or the terminal. The coordinate axis event changes a coordinate parameter of the virtual object at an i^{th} motion point, and the game program changes a position (i.e., three-dimensional coordinates) of the virtual object copy in the virtual environment within the editor interface according to the coordinate parameter of the motion point.

In some aspects, three coordinate axis rotation lines are displayed by using a reference point on the virtual object copy as a center in response to a trigger operation for the rotation control in a case that the i^{th} motion point is in a selected state. A rotation parameter of the virtual object copy in the virtual environment is changed in response to an operation of rotating the virtual object copy along any coordinate axis rotation line among the three coordinate axis rotation lines, and the changed rotation parameter is determined as the rotation parameter of the virtual object at the i^{th} motion point.

For example, the trigger operation performed by the user on the moving control by using the touchscreen triggers a coordinate axis drawing event, so that a display interface of an editor displays three coordinate axis rotation lines. An operation performed by the user for rotating any coordinate axis rotation line among the three coordinate axis rotation lines may trigger a coordinate axis event. According to a swiping operation performed by the user on the touchscreen, the terminal obtains coordinates of a pressing point and coordinates of a raising point of the swiping operation, to calculate a swiping distance. The game program triggers the coordinate axis event according to the swiping distance obtained from the operating system or the terminal. The coordinate axis event changes a rotation parameter of the virtual object at an i^{th} motion point, and the game program changes a rotation posture of the virtual object copy in the virtual environment within the editor interface according to the rotation parameter of the motion point.

In some aspects, three coordinate axis scaling lines are displayed by using a reference point on the virtual object copy as a center in response to a trigger operation for the scaling control in a case that the i^{th} motion point is in a selected state. In response to an operation of dragging along any coordinate axis scaling line among the three coordinate axis scaling lines, a scaling parameter of the virtual object copy in a coordinate axis dimension of the coordinate axis scaling line is changed, and the changed scaling parameter is determined as the scaling parameter of the virtual object at the i^{th} motion point.

For example, the trigger operation performed by the user on the moving control by using the touchscreen triggers a coordinate axis drawing event, so that a display interface of an editor displays three coordinate axis scaling lines. An operation performed by the user for dragging any coordinate axis scaling line among the three coordinate axis scaling lines may trigger a coordinate axis event. According to a swiping operation performed by the user on the touchscreen, the terminal obtains coordinates of a pressing point and coordinates of a raising point of the swiping operation, to calculate a swiping distance. The game program triggers the coordinate axis event according to the swiping distance obtained from the operating system or the terminal. The coordinate axis event changes a scaling parameter of the virtual object at an i^{th} motion point, and the game program changes a scaling ratio of the virtual object copy in the virtual environment within the editor interface according to the scaling parameter of the motion point.

In some aspects, in response to a trigger operation for the motion point control, an inputted duration is set as a duration for the motion of the virtual object from the i^{th} motion point to the (i+1)^{th} motion point in response to an operation of inputting a duration in a duration input box displayed on the motion point control.

For example, a preset value of the motion duration in the motion point data is 2 s. After the user enters a duration in the duration input box and stores the duration, the game program updates the motion duration in the motion point data to an input value, and saves the input value in the memory of the terminal by using the operating system. Alternatively, the game program transmits updated motion point data to the server by using the operating system and the terminal, and the server saves the updated motion point data in the database.

In some aspects, a motion cycle mode of the virtual object is set in response to a trigger operation for the motion cycle mode control. The motion cycle mode includes at least one of a one-way motion manner, a continuous one-way manner, or a cyclic reciprocating manner. The one-way motion manner is a manner of sequentially moving from a first motion point to a last motion point. The continuous one-way manner is a continuous motion manner of sequentially moving from the first motion point to the last motion point again after sequentially moving from the first motion point to the last motion point. The cyclic reciprocating manner is a reciprocating motion manner of sequentially moving from the first motion point to the last motion point, and then returning from the last motion point to a previous motion point until moving back to the first motion point.

For example, the setting parameter in the motion point data includes a motion cycle mode, and a preset value is a one-way motion manner. After the user sets the motion cycle mode by using the motion cycle mode control and saves the motion cycle mode, the game program updates the motion cycle mode in the motion point data to a modified motion cycle mode, and saves the modified motion cycle mode in the memory of the terminal by using the operating system. Alternatively, the game program transmits updated motion point data to the server by using the operating system and the terminal, and the server saves the updated motion point data in the database.

In some aspects, in response to a trigger operation for the automatic rotation control, a rotation parameter of the virtual object at the i^{th} motion point is set to a rotation parameter toward the (i+1)^{th} motion point.

For example, the setting parameter in the motion point data includes an automatic rotation parameter. A preset value is no. For example, automatic rotation is not performed. After the user sets an automatic rotation parameter by using the automatic rotation control and saves the automatic rotation parameter, the game program updates the automatic rotation parameter in the motion point data, and saves the automatic rotation parameter in the memory of the terminal by using the operating system. Alternatively, the game program transmits updated motion point data to the server by using the operating system and the terminal, and the server saves the updated motion point data in the database.

In some aspects, in response to a trigger operation for the speed smoothing control, a speed change process when the virtual object switches between two motion paths in front of and behind the intermediate motion point is set to a smooth change.

For example, the setting parameter in the motion point data includes a speed smoothing parameter. A preset value is no. For example, speed smoothing is not performed. After the user sets a speed smoothing parameter by using the speed smoothing control and saves the speed smoothing parameter, the game program updates the speed smoothing parameter in the motion point data, and saves the speed smoothing parameter in the memory of the terminal by using the operating system. Alternatively, the game program transmits updated motion point data to the server by using the operating system and the terminal, and the server saves the updated motion point data in the database.

In some aspects, in response to a trigger operation for the path smoothing control, a path change process when the virtual object switches between two motion paths in front of and behind the intermediate motion point is set to a smooth change.

For example, the setting parameter in the motion point data includes a path smoothing parameter. A preset value is no. For example, path smoothing is not performed. After the user sets a path smoothing parameter by using the path smoothing control and saves the path smoothing parameter, the game program updates the path smoothing parameter in the motion point data, and saves the path smoothing parameter in the memory of the terminal by using the operating system. Alternatively, the game program transmits updated motion point data to the server by using the operating system and the terminal, and the server saves the updated motion point data in the database.

In some aspects, in response to a trigger operation for the speed curve setting control, a speed curve of the virtual object moving from the i^{th} motion point to the (i+1)^{th} motion point is set.

For example, the setting parameter in the motion point data includes a speed curve, and a preset value is a straight line between two motion points. After the user sets the speed curve by using the speed curve setting control and saves the speed curve, the game program updates the speed curve in the motion point data to an input value, and saves the input value in the memory of the terminal by using the operating system. Alternatively, the game program transmits updated motion point data to the server by using the operating system and the terminal, and the server saves the updated motion point data in the database.

In some aspects, in response to a trigger operation for the motion preview control, a motion preview animation from the i^{th} motion point to the n^{th} motion point is displayed, where n is a positive integer, and i is a positive integer less than n. When rotation parameters of the i^{th} motion point and the (i+1)^{th} motion point are different, the motion preview animation displays a gradient rotation motion of a shortest rotation path changing from the rotation parameter of the i^{th} motion point to the rotation parameter of the (i+1)^{th} motion point. When scaling parameters of the i^{th} motion point and the (i+1)^{th} motion point are different, the motion preview animation displays a gradient scaling motion changing from the scaling parameter of the i^{th} motion point to a shortest scaling path of the scaling parameter of the (i+1)^{th} motion point.

For example, after the user performs a trigger operation on a motion preview control of an i^{th} motion point, the game program performs motion calculation by using a processor of the terminal based on motion point data from the i^{th} motion point to an n^{th} motion point, controls, according to a motion calculation result, a motion of the virtual object in the virtual environment based on the motion point, and displays the motion in the editor interface by using a display screen of the terminal. Alternatively, after the user performs a trigger operation on the motion preview control of the i^{th} motion point, a motion preview event is triggered. The game program transmits a motion preview request to the server by using the operating system and a terminal. The server performs motion calculation according to motion point data from the i^{th} motion point to the n^{th} motion point, controls, according to a motion calculation result, a motion of the virtual object in the virtual environment based on the motion point, and edits the motion into a motion preview animation response to the terminal. The terminal forwards the response to the game program by using the operating system, and the game program displays the motion preview animation on the editor interface by using the terminal.

Operation 530: Control a motion of the virtual object in the virtual environment based on the at least two motion points.

In some aspects, the server controls the motion of the virtual object in the virtual environment. Alternatively, the terminal controls the motion of the virtual object in the virtual environment.

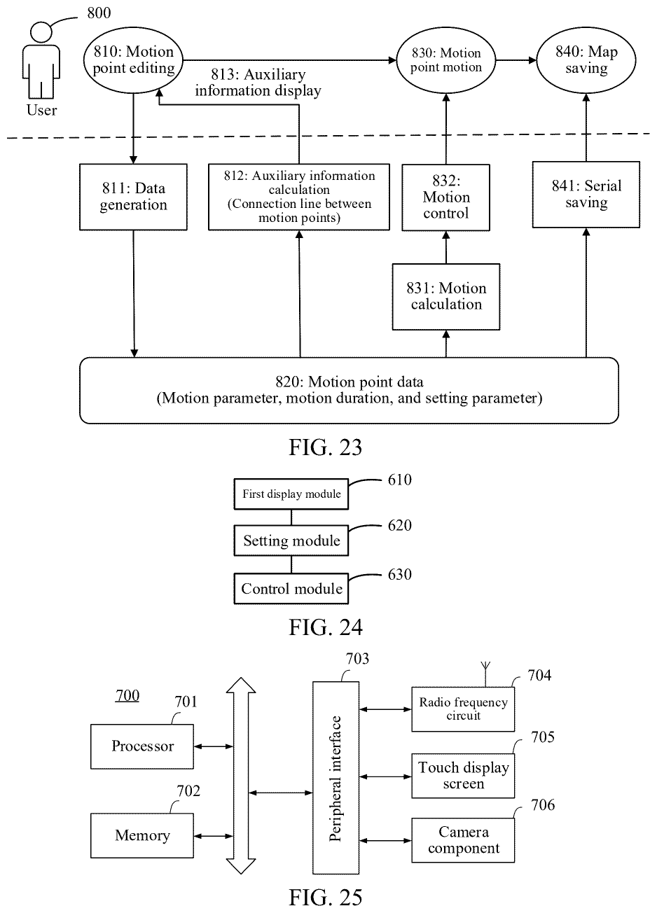

For example, as shown in FIG. 23, based on operations such as adding, editing, and setting performed by a user 800 on a motion point by using an interactive control, the game program generates motion point data 820 based on data generation 811. The motion point data 820 includes at least one of a motion parameter, a motion time, and a setting parameter of the motion point. The game program transmits the motion point data to the terminal by using the operating system, the terminal transmits the motion point data to the server by using a network, and finally, the server saves the motion point data in the database. In the process of motion point editing 810 by the user, the server performs auxiliary information calculation 812 according to the saved motion point data, and performs auxiliary information display 813 on the editor interface. When the user hopes to view a motion at a motion point 830 of the virtual object after completing the editing operation for the motion point, the server performs motion calculation 831 according to adjacent motion point data, performs motion control 832 on the virtual object according to a result of the motion calculation, and displays a motion process of the virtual object at the motion point on the editor interface. When the user performs an operation of map saving 840, the motion point data 820 is serially saved 841 into the server or the database.

In some aspects, the motion of a virtual object is controlled by a motion device. k motion devices may be provided for one virtual object. One motion device has n motion units. Each motion unit may be set to a different motion mode. The motion mode includes at least one of a motion point motion mode, a full motion mode, a rectilinear motion mode, a rotation motion mode, a scaling motion mode, or a spatial motion mode, where k and n are both positive integers.

For example, a virtual object a has a motion device b. The motion device b has three motion units b1, b2, and b3, where the motion unit b1 is set to a motion point motion mode, the motion unit b2 is set to a scaling motion mode, and the motion unit b3 is set to a spatial motion mode.

The following describes apparatus aspects of this disclosure, which may be configured for executing the method aspects of this disclosure. Details not disclosed in the apparatus aspects of this disclosure may be similar to those in the method aspects of this disclosure. Refer to FIG. 24, which shows a structural block diagram of an apparatus for generating UGC in a game program according to an aspect of this disclosure. The apparatus has a function of implementing the foregoing examples of the method for generating UGC in a game program, and the function may be implemented by hardware or may be implemented by hardware executing corresponding software. As shown in FIG. 24, the apparatus 600 may include: a first display module 610, a setting module 620, and a control module 630.

The first display module 610 is configured to display a virtual object located in a virtual environment in an editor interface of a UGC editor. The setting module 620 is configured to set a motion point for the virtual object in the virtual environment in response to a motion point editing operation for the virtual object, where the motion point indicates a motion parameter of the virtual object on a motion path of the virtual environment. The control module 630 is configured to control a motion of the virtual object in the virtual environment based on the motion point.

In some aspects, the setting module 620 includes an addition submodule and an editing submodule. The addition submodule is configured to add at least two motion points for the virtual object in the virtual environment in response to a motion point adding operation for the virtual object. The editing submodule is configured to set, in response to an editing operation for an i^{th} motion point of the at least two motion points, a motion parameter of the virtual object at the i^{th} motion point. The motion parameter includes at least one of a coordinate parameter, a rotation parameter, or a scaling parameter of the virtual object at the i^{th} motion point, where i is a positive integer.

In some aspects, the addition submodule includes a motion point creation unit. The motion point creation unit is configured to add, in a case that the virtual object already has n motion points, an (n+1)^{th} motion point to the virtual object in the virtual environment in response to a motion point creation operation for the virtual object. The (n+1)^{th} motion point is a motion point following an n^{th} motion point.

In some aspects, the addition submodule includes a motion point copy unit. The motion point copy unit is configured to insert, in response to a motion point copy operation for an i^{th} motion point of the virtual object in a case that the virtual object already has n motion points, a motion point between the i^{th} motion point and an (i+1)^{th} motion point among the n motion points, to obtain n+1 motion points of the virtual object. The inserted motion point is an (i+1)^{th} motion point among the n+1 motion points. The (i+1)^{th} motion point among the n motion points is shifted to an (i+2)^{th} motion point among the n+1 motion points, where n is a positive integer, and i is a positive integer less than n.

In some aspects, the editing submodule includes a first display unit, a first setting unit, a second display unit, and a first change unit. The first display unit is configured to display a moving control and a virtual object copy located at an i^{th} motion point in the editor interface. The second display unit is configured to display three coordinate axis moving lines by using a reference point on the virtual object copy as a center in response to a trigger operation for the moving control in a case that the i^{th} motion point is in a selected state. The first change unit is configured to change a coordinate parameter of the virtual object copy in the virtual environment in response to an operation of moving the virtual object copy along any coordinate axis moving line, and determine the changed coordinate parameter as the coordinate parameter of the virtual object at the i^{th} motion point.

In some aspects, the editing submodule includes a third display unit, a fourth display unit, and a second change unit. The third display unit is configured to display a rotation control and a virtual object copy located at an i^{th} motion point in the editor interface. The fourth display unit is configured to display three coordinate axis rotation lines by using a reference point on the virtual object copy as a center in response to a trigger operation for the rotation control in a case that the i^{th} motion point is in a selected state. The second change unit is configured to change a rotation parameter of the virtual object copy in the virtual environment in response to an operation of rotating the virtual object copy along any coordinate axis rotation line, and determine the changed rotation parameter as the rotation parameter of the virtual object at the i^{th} motion point.

In some aspects, the editing submodule includes a fifth display unit, a sixth display unit, and a third change unit. The fifth display unit is configured to display a scaling control and a virtual object copy located at an i^{th} motion point in the editor interface. The sixth display unit is configured to display three coordinate axis scaling lines by using a reference point on the virtual object copy as a center in response to a trigger operation for the scaling control in a case that the i^{th} motion point is in a selected state. The third change unit is configured to change, in response to an operation of dragging along any coordinate axis scaling line, a scaling parameter of the virtual object copy in a coordinate axis dimension of the coordinate axis scaling line, and determine the changed scaling parameter as the scaling parameter of the virtual object at the i^{th} motion point.

In some aspects, the setting module 620 further includes a duration setting submodule. The duration setting submodule is configured to set a motion duration for a motion of the virtual object from the i^{th} motion point to the (i+1)^{th} motion point in response to a duration setting operation.

In some aspects, the duration setting submodule includes a seventh display unit and a first setting unit. The seventh display unit is configured to display a motion point control of the i^{th} motion point on the editor interface, where a duration input box is displayed on the motion point control. The first setting unit is configured to set the motion duration for the motion of the virtual object from the i^{th} motion point to the (i+1)^{th} motion point as an inputted duration in response to an operation of inputting a duration in the duration input box.

In some aspects, the setting module 620 further includes a mode setting submodule. The mode setting submodule is configured to set a motion cycle mode of the virtual object in response to a motion cycle mode setting operation. The motion cycle mode includes at least one of a one-way motion manner, a continuous one-way manner, or a cyclic reciprocating manner. The one-way motion manner is a manner of sequentially moving from a first motion point to a last motion point. The continuous one-way manner is a continuous motion manner of sequentially moving from the first motion point to the last motion point again after sequentially moving from the first motion point to the last motion point. The cyclic reciprocating manner is a reciprocating motion manner of sequentially moving from the first motion point to the last motion point, and then returning from the last motion point to a previous motion point until moving back to the first motion point.

In some aspects, the setting module 620 further includes an automatic rotation submodule. The automatic rotation submodule is configured to set a rotation parameter of the virtual object at the i^{th} motion point to a rotation parameter toward the (i+1)^{th} motion point in response to an automatic rotation operation for the i^{th} motion point.

In some aspects, the setting module 620 further includes a speed smoothing submodule. The speed smoothing submodule is configured to set a speed change process when the virtual object switches between two motion paths in front of and behind the intermediate motion point to a smooth change in response to a speed smoothing operation for the intermediate motion point.

In some aspects, the setting module 620 further includes a path smoothing submodule. The path smoothing submodule is configured to set a path change process when the virtual object switches between two motion paths in front of and behind the intermediate motion point to a smooth change in response to a path smoothing operation for the intermediate motion point.

In some aspects, the setting module 620 further includes a display submodule and a speed curve submodule. The display submodule is configured to display a speed curve setting control from the i^{th} motion point to the (i+1)^{th} motion point. The speed curve submodule is configured to set a speed curve of the virtual object moving from the i^{th} motion point to the (i+1)^{th} motion point in response to a setting operation for the speed curve setting control.

In some aspects, the setting module 620 further includes a motion preview submodule. The motion preview submodule is configured to display a motion preview animation from the i^{th} motion point to an n^{th} motion point in response to a motion preview operation for the i^{th} motion point to the (i+1)^{th} motion point. When rotation parameters of the i^{th} motion point and the (i+1)^{th} motion point are different, the motion preview animation includes a gradient rotation motion of a shortest rotation path changing from the rotation parameter of the i^{th} motion point to the rotation parameter of the (i+1)^{th} motion point. When scaling parameters of the i^{th} motion point and the (i+1)^{th} motion point are different, the motion preview animation includes a gradient scaling motion changing from the scaling parameter of the i^{th} motion point to a shortest scaling path of the scaling parameter of the (i+1)^{th} motion point, where i is a positive integer.

In some aspects, the motion preview submodule includes an eighth display unit and a ninth display unit. The eighth display unit is configured to display a motion preview control for the at least two motion points on the editor interface, where the at least two motion points include n motion points. The ninth display unit is configured to display a motion preview animation from the i^{th} motion point to the n^{th} motion point in response to a trigger operation for a motion preview control of the it^{h} motion point.

In some aspects, the apparatus 600 further includes a second display module. The second display module is configured to display auxiliary information in the editor interface in response to a motion point editing operation for the virtual object, where the auxiliary information includes at least one of a starting point identifier, a motion connection line, a selected motion point, or an unselected motion point.

The apparatus provided in the foregoing aspect implements the functions of the apparatus, only division of the foregoing functional modules is described by using examples. In a practical application, the functions may be completed by different functional modules as required. For example, an internal structure of a device is divided into different functional modules to complete all or part of the functions described above. In addition, the apparatus provided in the foregoing aspect belongs to the same idea as the method aspect. For a specific implementation process thereof, reference can be made to the method aspect. Details are not described herein again.

FIG. 25 is a block diagram of a structure of a computer device according to an aspect of this disclosure.

The computer device 700 may be a portable mobile terminal, also referred to as a mobile terminal in this aspect. For example, the computer device is a smartphone, a tablet computer, a Moving Picture Experts Group Audio Layer III (MP3) player, or a Moving Picture Experts Group Audio Layer IV (MP4) player. The computer device 700 includes a processor 701 and a memory 702.

The processor 701 may include one or more processing cores, for example, a 4-core processor or an 8-core processor. The processor 701 may be implemented in at least one hardware form of a digital signal processor (DSP), a field programmable gate array (FPGA), and a programmable logic array (PLA). The processor 701 may further include a main processor and a coprocessor. The main processor is a processor configured to process data in an awake state, and is also referred to as a central processing unit (CPU). The coprocessor is a low power consumption processor configured to process the data in a standby state.

The memory 702 may include one or more computer-readable storage media. The computer-readable storage medium may be tangible and non-transient. The memory 702 may further include a high-speed random access memory and a nonvolatile memory, for example, one or more disk storage devices or flash storage devices. In some aspects, a non-transitory computer-readable storage medium in the memory 702 is configured to store at least one instruction. The at least one instruction is configured for being executed by the processor 701, to implement the method for generating UGC in a game program provided in the foregoing aspect of this disclosure.

In some aspects, the computer device 700 may include a peripheral device interface 703 and at least one peripheral device. For example, the peripheral device includes at least one of a radio frequency (RF) circuit 704, a touch display screen 705, and a camera 706.

The peripheral interface 703 may be configured to connect the at least one peripheral related to input/output (I/O) to the processor 701 (an example of processing circuitry) and the memory 702 (an example of a non-transitory computer-readable storage medium). In some aspects, the processor 701, the memory 702 and the peripheral device interface 703 are integrated on a same chip or circuit board. In some other aspects, any one or two of the processor 701, the memory 702, and the peripheral device interface 703 may be implemented on a single chip or circuit board. This is not limited in this aspect.

The RF circuit 704 is configured to receive and transmit an RF signal, also referred to as an electromagnetic signal. The RF circuit 704 communicates with a communication network and other communication devices through the electromagnetic signal. The RF circuit 704 converts an electric signal into an electromagnetic signal for transmission, or converts a received electromagnetic signal into an electric signal.

The touch display screen 705 is configured to display a user interface (UI). The UI may include a graph, text, an icon, a video, and any combination thereof. The touch display screen 705 further has a capability of acquiring a touch signal on or above a surface of the touch display screen 705. The touch signal may be inputted to the processor 701 as a control signal for processing. The touch display screen 705 is configured to provide a virtual button and/or a virtual keyboard that are/is also referred to as a soft button and/or a soft keyboard.

The camera component 706 is configured to acquire images or videos. In some aspects, the camera component 706 includes a front-facing camera and a rear-facing camera. The front camera is configured to implement a video call or self-portrait, and the rear camera is configured to shoot a picture or a video.

It is noted that the structure shown in FIG. 25 constitutes no limitation on the computer device 700, and the computer device may include more or fewer components than those shown in the figure, or some components may be combined, or a different component deployment may be used.

In an aspect, this disclosure provides a chip. The chip includes a programmable logic circuit and/or program instructions. When running on a computer device, the chip is configured to implement the method for generating UGC in a game program provided in the foregoing method aspect.

This disclosure provides a computer-readable storage medium, such as a non-transitory computer-readable storage medium. The computer-readable storage medium has a computer program stored therein. The computer program is loaded and executed by a processor to implement the method for generating UGC in a game program provided in the foregoing method aspect.

This disclosure provides a computer program product or a computer program. The computer program product or the computer program includes computer instructions, and the computer instructions are stored in a computer-readable storage medium. A processor of a computer device reads the computer instructions from the computer-readable storage medium. The processor executes the computer instructions, so that the processor of the computer device loads and executes the computer instructions to implement the method for generating UGC in a game program provided in the foregoing method aspect.

It is noted that all or some of the operations of the foregoing aspects may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely example aspects of this disclosure, and are not intended to limit this disclosure. Any modification, equivalent replacement, or improvement made within the spirit and principle of this disclosure shall fall within the scope of this disclosure.

What is claimed is:

1. A method for generating user generated content (UGC) in a game program, the method comprising:
outputting for display, in an editor interface of a UGC editor, a virtual object located in a virtual environment;
setting, based on a motion point editing operation performed on a motion path of the virtual object, at least one motion point for the virtual object in the virtual environment, the at least one motion point indicating a motion parameter of the virtual object on the motion path of the virtual environment; and
controlling a motion of the virtual object in the virtual environment based on the at least one motion point.

2. The method according to claim 1, wherein the setting the at least one motion point comprises:
adding at least two motion points for the virtual object in the virtual environment based on a motion point adding operation performed on the motion path of the virtual object; and
setting, based on an editing operation performed on an i^{th} motion point of the at least two motion points, a motion parameter of the virtual object at the i^{th} motion point, the motion parameter including at least one of a coordinate parameter, a rotation parameter, or a scaling parameter of the virtual object at the i^{th} motion point, i being a positive integer.

3. The method according to claim 2, further comprising:
outputting for display a moving control element and a virtual object copy located at the i^{th} motion point in the editor interface;
outputting for display, based on a trigger operation performed on the moving control element while the i^{th} motion point is in a selected state, three coordinate axis moving lines centered on a reference point of the virtual object copy;
changing a coordinate parameter of the virtual object copy based on a movement operation to move the virtual object copy along one of the three coordinate axis moving lines; and
determining the changed coordinate parameter as the coordinate parameter of the virtual object at the i^{th} motion point, i being a positive integer.

4. The method according to claim 2, further comprising:
outputting for display a rotation control element and a virtual object copy located at the i^{th} motion point in the editor interface;
outputting for display three coordinate axis rotation lines centered on a reference point of the virtual object copy based on a trigger operation performed on the rotation control element while the i^{th} motion point is in a selected state;
changing a rotation parameter of the virtual object copy based on a rotation operation to rotate the virtual object copy on a plane of one of the three coordinate axis rotation lines; and
determining the changed rotation parameter as the rotation parameter of the virtual object at the i^{th} motion point, i being a positive integer.

5. The method according to claim 2, further comprising:
outputting for display a scaling control element and a virtual object copy located at the i^{th} motion point in the editor interface;
outputting for display three coordinate axis scaling lines centered on a reference point of the virtual object copy based on a trigger operation performed on the scaling control element while the i^{th} motion point is in a selected state;
changing, based on dragging operation on the virtual object copy in one of the three coordinate axis scaling lines, a scaling parameter of the virtual object copy; and
determining the changed scaling parameter as the scaling parameter of the virtual object at the i^{th} motion point, i being a positive integer.

6. The method according to claim 2, wherein the adding the at least two motion points comprises:
adding, when the virtual object has n motion points, an (n+1)^{th} motion point following an n^{th} motion point based on a new motion point creation operation performed on the motion path of the virtual object, n being a positive integer.

7. The method according to claim 2, wherein the adding the at least two motion points comprises:
inserting, based on a motion point copy operation performed on the i^{th} motion point when the motion path of the virtual object includes n motion points, a new motion point between the i^{th} motion point and an (i+1)^{th} motion point of the n motion points to obtain (n+1) motion points, the new motion point being an (i+1)^{th} motion point of the (n+1) motion points, and the (i+1)^{th} motion point of the n motion points being an (i+2)^{th} motion point of the (n+1) motion points, n being a positive integer, and i being a positive integer less than n.

8. The method according to claim 1, further comprising:
generating a first motion point based on a coordinate parameter, a rotation parameter, and a scaling parameter of the virtual object currently in the virtual environment based on a motion mode of the virtual object.

9. The method according to claim 2, further comprising:
when the at least two motion points include the i^{th} motion point and an (i+1)^{th} motion point, setting, based on a motion duration setting operation performed on the virtual object, a motion duration for movement of the virtual object from the i^{th} motion point to the (i+1)^{th} motion point, i being a positive integer.

10. The method according to claim 9, further comprising:
outputting for display, in the editor interface, a motion point control element of the i^{th} motion point, the motion point control element including a motion duration input box; and
setting the motion duration for the virtual object from the i^{th} motion point to the (i+1)^{th} motion point based on a motion duration input via the motion duration input box.

11. The method according to claim 1, further comprising:
setting, based on a motion cycle mode setting operation, a motion cycle mode of the virtual object, the motion cycle mode including:
a one-way motion manner in which the virtual object sequentially moves along the motion path from a first motion point to a last motion point,
a continuous one-way manner in which the virtual object repeatedly moves along the motion path from the first motion point to the last motion point, or a cyclic reciprocating manner in which the virtual object sequentially moves along the motion path from the first motion point to the last motion point, and back from the last motion point to the first motion point.

12. The method according to claim 2, further comprising:
when the at least two motion points include the i^{th} motion point and an (i+1)^{th} motion point, setting, based on an automatic rotation operation performed on the i^{th} motion point, the rotation parameter of the virtual object at the i^{th} motion point to a rotation parameter oriented toward the (i+1)^{th} motion point, i being a positive integer.

13. The method according to claim 2, further comprising:
setting, based on a speed smoothing operation performed on an intermediate motion point located between a first motion point and a last motion point, a gradual transition of speed between motion path segments before and after the intermediate motion point.

14. The method according to claim 2, further comprising:
setting, based on a path smoothing operation performed on an intermediate motion point located between a first motion point and a last motion point, a gradual transition path segment between motion path segments before and after the intermediate motion point.

15. The method according to claim 2, further comprising:
when the at least two motion points include the i^{th} motion point and an (i+1)^{th} motion point, outputting for display, in the editor interface, a speed curve setting control element for movement from the i^{th} motion point to the (i+1)^{th} motion point; and
setting, based on a setting operation performed on the speed curve setting control element, a speed curve of the virtual object moving from the i^{th} motion point to the (i+1)^{th} motion point, i being a positive integer.

16. The method according to claim 2, further comprising:
when the at least two motion points include the i^{th} motion point and an (i+1)^{th} motion point, outputting for display a motion preview animation from the i^{th} motion point to the (i+1)^{th} motion point based on a motion preview operation performed on the i^{th} motion point, the motion preview animation including:
a gradient rotation motion along a shortest rotation path when rotation parameters differ between the i^{th} motion point and the (i+1)^{th} motion point, and
a gradient scaling motion along a shortest scaling path when scaling parameters differ between the i^{th} motion point and the (i+1)^{th} motion point, i being a positive integer.

17. The method according to claim 2, further comprising:
outputting for display, in the editor interface, a motion preview control element for the at least two motion points, the at least two motion points including n motion points; and
outputting for display a motion preview animation from the i^{th} motion point to an n^{th} motion point based on a trigger operation performed on the motion preview control element of the i^{th} motion point, n being a positive integer, and i being a positive integer less than n.

18. The method according to claim 1, further comprising:
outputting for display, in the editor interface, auxiliary information based on the motion point editing operation performed on the motion path of the virtual object, the auxiliary information including at least one of a starting point identifier, a motion connection line, a selected motion point, or an unselected motion point.

19. An information processing apparatus, comprising:
processing circuitry configured to:
output for display, in an editor interface of a UGC editor, a virtual object located in a virtual environment;
set, based on a motion point editing operation performed on a motion path of the virtual object, at least one motion point for the virtual object in the virtual environment, the at least one motion point indicating a motion parameter of the virtual object on the motion path of the virtual environment; and
control a motion of the virtual object in the virtual environment based on the at least one motion point.

20. A non-transitory computer-readable storage medium storing instructions which, when executed by a processor, cause the processor to perform:
outputting for display, in an editor interface of a UGC editor, a virtual object located in a virtual environment;
setting, based on a motion point editing operation performed on a motion path of the virtual object, at least one motion point for the virtual object in the virtual environment, the at least one motion point indicating a motion parameter of the virtual object on the motion path of the virtual environment; and
controlling a motion of the virtual object in the virtual environment based on the at least one motion point.
